(19) United States
(12) Patent Application Publication
(10) Pub. No.: US 2025/0165711 A1
(43) Pub. Date: May 22, 2025

(54) CONSTRAINING OUTPUT OF A GENERATIVE LANGUAGE MODEL TO CONFORM TO A GRAMMAR

(71) Applicant: Shopify Inc., Ottawa (CA)

(72) Inventors: David Libbey, Westport (CA); Neil Leonard Padgett, Toronto (CA)

(21) Appl. No.: 18/649,251

(22) Filed: Apr. 29, 2024

Related U.S. Application Data
(63) Continuation-in-part of application No. 18/512,781, filed on Nov. 17, 2023.

(51) Int. Cl. G06F 40/284

(52) U.S. Cl. CPC G06F 40/284

(57) ABSTRACT

One problem of a generative language model (e.g. a large language model) is the generation of syntactically-invalid or misinformed output. This may be mitigated by utilizing a grammar defining valid sequences of output. The grammar may constrain the token generation. A method may include obtaining values generated using the generative language model, where each value is indicative of a probability of a respective token being a next token in the token sequence. The method may further include obtaining a mask based on the token sequence already generated and the grammar. The method may further include applying the mask to the values. The mask may operate on each value that corresponds to a token not compliant with the grammar to reduce or zero the probability of the corresponding token being the next token. The next token is then determined based on the values after the mask is applied.

### CROSS-REFERENCE TO RELATED APPLICATIONS

The present application is a continuation-in-part of U.S. patent application Ser. No. 18/512,781, which was filed Nov. 17, 2023, and which is incorporated herein by reference.

### FIELD

The present application relates to generative language machine learning models, such as large language models (LLMs).

### BACKGROUND

A generative language model is a machine learning model that generates language, typically in the form of text in response to an input prompt. A generative language model may utilize a large neural network to determine probabilities for a next token of a sequence of text conditional on previous or historical tokens in the sequence of text. A large language model (LLM) is an example of a generative language model.

### SUMMARY

One technical problem associated with a generative language model, such as an LLM, is the generation of syntactically-invalid or misinformed output. The syntactically-invalid or misinformed output may sometimes be in the form of (or be referred to as) “hallucination”. An example is an event in which the generative language model generates output (e.g. text) that is incorrect or not coherent. The problem can occur because of factors such as incomplete training or fine-tuning of the generative language model. In one example, this may result when, during training of the generative language model, an encoder of the generative language model learns wrong correlations between different parts of the training data. The performance of the generative language model suffers because the generative language model is not generating correct coherent output. Conventional methods to address this technical problem have included: additional fine-tuning training of the generative language model, e.g. using high-quality data sets to try to minimize the model learning wrong correlations between training data, and/or prompt engineering to form input prompts to the generative language model that aim to reduce occurrences of the problem, and/or post-process “filtering” to try to flag or remove such output, etc. However, these conventional methods can be computationally intensive and/or complex, and they do not always adequately mitigate the problem.

In embodiments herein, the technical problem may be mitigated by utilizing a grammar defining valid sequences of output. The grammar is used to constrain the output from the generative language model. For example, if the generative language model is being used to generate JavaScript Object Notation (JSON) key-value pairs of recipe ingredients and quantity of each ingredient, the grammar may define that an open curly bracket must be followed by a string in quotation marks, which must be followed by a colon, which must be followed by a number in quotation marks, which must be followed by a comma or a closing curly bracket. A naïve approach would be to check whether an output from the generative language model is compliant with the grammar and, if not, discard the output and instruct the generative language model to instead provide another output. For example, assuming the example introduced above in which the generative language model is being used to generate JSON key-value pairs of recipe ingredients and quantity of each ingredient, if the immediately preceding output from the generative language model is {“bananas”:” then the grammar may be used to check that the next output of the generative language model is a number. If it is not, e.g. if it is one or more letters of the alphabet, then discard the output and instruct the generative language model to provide another output. However, this approach may be slow and computationally intensive, e.g. it may take many iterations of regenerating outputs and, for each regeneration of the output, checking whether the output is compliant with the grammar. Instead, in some implementations herein, the grammar is applied to constrain the token generation itself in the generative language model. Each token not compliant with the grammar has its associated probability reduced or zeroed so that only a token compliant with the grammar is output as the next token in the token sequence generated by the generative language model. For example, if the next valid output can only be a number, then the probability associated with all tokens that are not numbers is reduced or zeroed such that the next token output from the generative language model is a number. As a result, only a token compliant with the grammar is output as the next token, and therefore the generated token sequence maintains compliance with the grammar. By maintaining compliance with the grammar, syntactically-invalid or misinformed/hallucinated output may be mitigated because the output is constrained to valid output defined by the grammar.

One example implementation is as follows. The generative language model generates a sequence of tokens, where each next token in the sequence is determined based on one or more previously generated tokens of the sequence. The next token is selected as having a high (or highest) probability of being the next token given one or more tokens of the sequence already generated. To determine the next token, the generative language model generates a plurality of values, where each of the plurality of values is indicative of a probability of a respective token being the next token. For example, a layer of a neural network in the generative language model may output a tensor that includes the plurality of values, in which case each value of the plurality of values may represent an unnormalized probability that the token corresponding to that value is the next token. Each value of the plurality of values may be a log it value. A mask is applied to operate on each value of the plurality of values that corresponds to a token not compliant with the grammar to reduce or zero the probability of that token being the next token. For example, if the plurality of values is the tensor referred to above, the mask may be another tensor, and applying the mask may be implemented by performing a tensor product of the two tensors or the equivalent. The mask may result in modifying each value that corresponds to a token not compliant with the grammar in order to effectively zero (or close to zero) the probability of that token being selected as the next token. As a result, only a token compliant with the grammar is selected as the next token, and therefore the generated token sequence maintains compliance with the grammar.

In one aspect, there is provided a computer-implemented method. The method may include obtaining a plurality of values generated using a generative language model, where each of the values is indicative of a probability of a respective token being a next token in a token sequence generated by the generative language model. The method may further include obtaining a mask based on at least one token of the token sequence already generated by the generative language model and based on a grammar defining valid sequences of output. The method may further include applying the mask to the plurality of values. The mask may operate on each value that corresponds to a token not compliant with the grammar to reduce or zero the probability of the corresponding token being the next token. The next token is then determined based on the plurality of values after the mask is applied.

In some implementations, obtaining the mask may include determining a set of valid next tokens based on the at least one token of the token sequence already generated by the generative language model and based on the grammar. In some implementations, the set of valid next tokens consists of one or more tokens any one of which, when appended to the token sequence, results in the token sequence still being compliant with the grammar. In some implementations, the mask may be generated by, for each token not in the set of valid next tokens, generating a corresponding masking value that, when applied, reduces or zeros the probability of the token being the next token.

In some implementations, obtaining the plurality of values may include generating a first tensor in a neural network of the generative language model, the first tensor including the plurality of values. In some implementations, the mask may be a second tensor, and applying the mask may include performing a tensor product of the first tensor and the second tensor.

In some implementations, tokens not in the set of valid next tokens are invalid next tokens. In some implementations, at each position in the second tensor that corresponds to a valid next token there may be an identity element that does not modify the value in the first tensor corresponding to the valid next token when the tensor product is performed. In some implementations, at each position in the second tensor that corresponds to an invalid next token there may be the corresponding masking value that does modify the value in the first tensor corresponding to the invalid next token when the tensor product is performed to reduce or zero the probability of the invalid next token being the next token.

In some implementations, the plurality of values may be a plurality of normalized probability values output from a softmax function of the generative language model. In some implementations, applying the mask may include reducing or setting to zero probability each of the normalized probability values that corresponds to a token not compliant with the grammar.

In some implementations, generating the plurality of values using the generative language model and the applying the mask may be implemented on a first processing unit. In some implementations, determining the set of valid next tokens and the generating the mask is implemented on a second processing unit. In some implementations, the method may include transmitting the mask from the second processing unit to the first processing unit. In some implementations, the first processing unit may be a specialized processing unit, e.g. a graphics processing unit (GPU). In some implementations, the second processing unit may be a non-specialized processing unit, e.g. a general purpose processor.

In some implementations, the method may include determining, for each token of a plurality of tokens, whether that token is in the set of valid next tokens. In some implementations, the plurality of tokens may be a set of tokens containing fewer than all possible tokens that can be generated by the generative language model. In some implementations, the set of tokens may be determined by retrieving all tokens having a prefix equal to a start of a next possible valid token. In some implementations, all possible tokens that can be generated by the generative language model may be stored in the form of a tree. In some implementations, the set of tokens may correspond to at least one branch of the tree and fewer than all branches of the tree.

In some implementations, the grammar defines terminal symbols and one or more rules that define how the terminal symbols can be arranged in relation to each other to define the valid sequences of output. In some implementations, for each terminal symbol of one or more of the terminal symbols, the terminal symbol may be divided into two or more constituent symbols, each constituent symbol corresponding to a respective possible output token that can be generated by the generative language model. In some implementations, the valid sequences of output defined by the grammar include valid sequences of output tokens based on the constituent symbols. In some implementations, the grammar before the terminal symbol is divided into the two or more constituent symbols is an original grammar, and the grammar after the terminal symbol is divided into the two or more constituent symbols is a tokenized grammar. In some implementations, generating the tokenized grammar may include: obtaining the original grammar and obtaining an indication of the tokens that can be output by the generative language model; and modifying the original grammar to result in the tokenized grammar by, for each terminal symbol of one or more of the terminal symbols of the original grammar, dividing the terminal symbol into the two or more constituent symbols, each constituent symbol corresponding to a respective possible output token that can be generated by the generative language model.

In another aspect, a system is disclosed that is configured to perform any of the methods disclosed herein. For example, the system may include a memory to store the grammar defining valid sequences of output and at least one processing unit to perform the method steps, e.g. the at least one processing unit may perform steps such as the obtaining the plurality of values generated using the generative language model, the obtaining the mask, and the applying the mask. In some implementations, there may be processor executable instructions stored in at least one memory that, when executed, cause the at least one processing unit to perform the method steps. In some implementations, the at least one processing unit may include a first processing unit and a second processing unit. The first processing unit and the second processing unit may communicate with each other, e.g. over a network or bus. The first processing unit may perform some of the steps, e.g. generate the plurality of values using the generative language model and apply the mask. The second processing unit may perform other steps, e.g. determine the set of valid next tokens, generate the mask, and transmit the mask to the first processing unit. The first processing unit may be a specialized processing unit implementing the generative language model, e.g. it may be a graphics processing unit (GPU). The second processing unit may be a non-specialized (e.g. general purpose) processor, e.g. it may be a central processing unit (CPU). A processing unit may alternatively be referred to as a processor.

In another aspect, there is provided one or more computer-readable storage media having stored thereon computer-executable instructions that, when executed by at least one processing unit, cause the at least one processing unit to perform any of the methods disclosed herein. The one or more computer-readable storage media may be non-transitory.

### BRIEF DESCRIPTION OF THE DRAWINGS

Embodiments will be described, by way of example only, with reference to the accompanying figures wherein:

FIG. 1A is a simplified block diagram of a simplified convolutional neural network;

FIG. 1B is a simplified block diagram of an example transformer neural network;

FIG. 2 is a block diagram of an example computing system;

FIG. 3 illustrates an example of a generative language model generating a sequence of tokens;

FIGS. 4 and 5 illustrate examples of applying a mask;

FIG. 6 illustrates another example of a generative language model generating a sequence of tokens;

FIGS. 7 and 8 illustrate additional examples of applying a mask;

FIG. 9 illustrates another example of a generative language model generating a sequence of tokens;

FIGS. 10 and 11 illustrate additional examples of applying a mask;

FIG. 12 illustrates a system for constraining an output of a generative language model using a grammar, according to one implementation;

FIG. 13 illustrates a variation of the system of FIG. 12;

FIG. 14 illustrates a computer-implemented method, according to one aspect;

FIG. 15 illustrates a specific example implementation of mask generation;

FIG. 16 illustrates one example of a trie for an LLM;

FIG. 17 illustrates an example multi-step process for branch elimination to reduce the number of comparisons; and

FIG. 18 illustrates an example of grammar tokenization.

### DETAILED DESCRIPTION

For illustrative purposes, specific embodiments will now be explained in greater detail below in conjunction with the figures.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

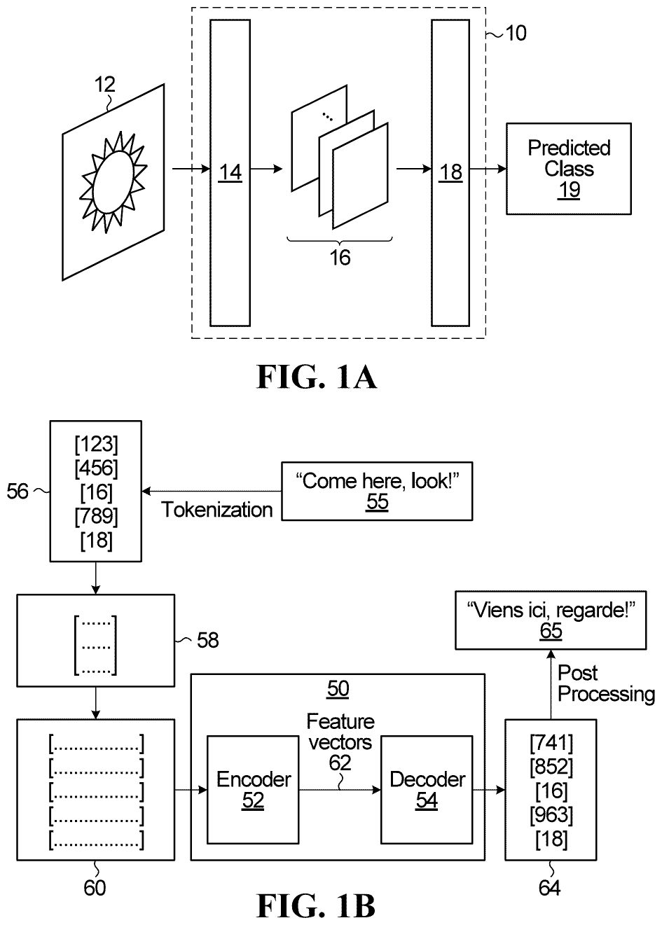

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3 (or GPT-4 or Gemini or Claude etc.), via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

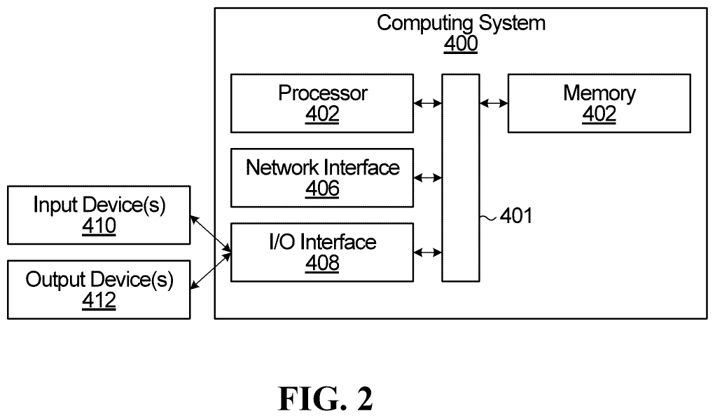

FIG. 2 illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### Constraining an Output of a Generative Language Model Based on a Grammar

As discussed above, a generative language model, such as an LLM, may generate syntactically-invalid or misinformed output. This problem may be mitigated by utilizing a grammar defining valid sequences of output. By maintaining compliance with the grammar, syntactically-invalid or misinformed output may be mitigated because the output of the generative language model is constrained to valid output defined by the grammar. In the examples below, the grammar is used to constrain the output from the generative language model itself. Specifically, the grammar is applied to constrain the token generation in the generative language model. A token is only generated that can be compliant with the grammar, which is achieved by reducing or zeroing the probability that a token not compliant with the grammar is output as the next token in the token sequence generated by the generative language model.

A grammar may define terminal symbols and one or more rules that define how the terminal symbols can be arranged in relation to each other to define the valid sequences of output. One example of a grammar is a programming language grammar that defines elementary symbols of the programming language (the terminal symbols of the grammar) and rules as to how the symbols may be arranged in relation to each other to define statements and expressions that are valid for the programming language. To assist with the explanation, one example simple grammar of a programming language is as follows:

Terminal Symbols: if then =
pagetitle pagebody black blue bold blur

```
Rules:
  <if-statement> :== if <condition> then <assignment>
  <condition> :== <variable> = <color>
  <assignment> :== <variable> = <effect>
  <variable> :== pagetitle | pagebody
  <color> :== black | blue
  <effect> :== bold | blur
```

As mentioned above, the terminal symbols are the elementary symbols of the programming language. All valid statements and expressions of the programming language can only include terminal symbols, arranged in relation to each other according to the rules of the grammar in order to define valid statements and expressions. In the example above, there are only nine terminal symbols defined for simplicity, which are: if then=pagetitle pagebody black blue bold blur.

The example grammar above also defines non-terminal symbols. The non-terminal symbols are symbols that can be replaced. In the example grammar above, the non-terminal symbols are all symbols beginning with “<” and ending with “>”, i.e.: <if-statement> <condition> <assignment> <variable> <color> <effect>. The example grammar above also defines rules that define how the terminal symbols can be arranged in relation to each other to define the valid sequences of output. In the example above, one of the rules is <if-statement>: ==if <condition> then <assignment>. This means that a valid if-then statement must have the terminal symbol “if” followed by the non-terminal symbol <condition> followed by the terminal symbol “then” followed by the non-terminal symbol <assignment>. The rules also specify that the non-terminal symbol <condition> must be the non-terminal symbol <variable> followed by the terminal symbol “=” followed by the non-terminal symbol <color>. The rules also specify that the non-terminal symbol <variable> must only be the terminal symbol “pagetitle” or the terminal symbol “pagebody”. The rules also specify that the non-terminal symbol <color> must only be the terminal symbol “black” or the terminal symbol “blue”. The rules further specify that the non-terminal symbol <assignment> must be the non-terminal symbol <variable> followed by the terminal symbol “=” followed by the non-terminal symbol <effect>. The rules further specify that the non-terminal symbol <effect> must only be the terminal symbol “bold” or the terminal symbol “blur”.

The valid statements and expressions of the programming language are only those that follow the rules of the grammar. For example, in the grammar introduced above an example of a valid statement is “if pagetitle=blue then pagebody=bold”, and an example of an invalid statement is “if blue then=pagetitle”.

The example grammar introduced above may be used to constrain the output of the generative language model to mitigate syntactically-invalid or misinformed output, which in this scenario would be incorrect output that would not compile and/or execute.

Consider a simple example in which an LLM can only generate the following tokens: =if ti bo dy ld tle then blue page blur black. This example is simplified for ease of explanation. In actuality, the LLM would typically be able to generate thousands of different tokens. During operation, in response to a prompt, the LLM generates a token sequence consisting of multiple ones of some or all of these tokens output one after the other. In the explanations herein, each token is illustrated/described in the form of text, but it will be appreciated that in implementation the token may just be a number that, via post-processing, is mapped to corresponding text, e.g. mapped to a numerical representation of one or more characters or segments of text, such as American standard code for information interchange (ASCII) or Unicode. Each token may be equal to or a portion of a terminal symbol of the grammar, although more generally this need not be the case (e.g. the LLM may be able to generate tokens that are not equal to or part of terminal symbols of the grammar).

Continuing the example introduced above, when generating a next token given the sequence of previous tokens, the LLM can only select one of the following tokens as the next token: =if ti bo dy ld tle then blue page blur black. There may be a non-zero probability that the next token selected is one that, when appended onto the sequence, results in an invalid statement or expression of the programming language, i.e. causes the sequence to not be compliant with the valid sequences of output defined by the grammar.

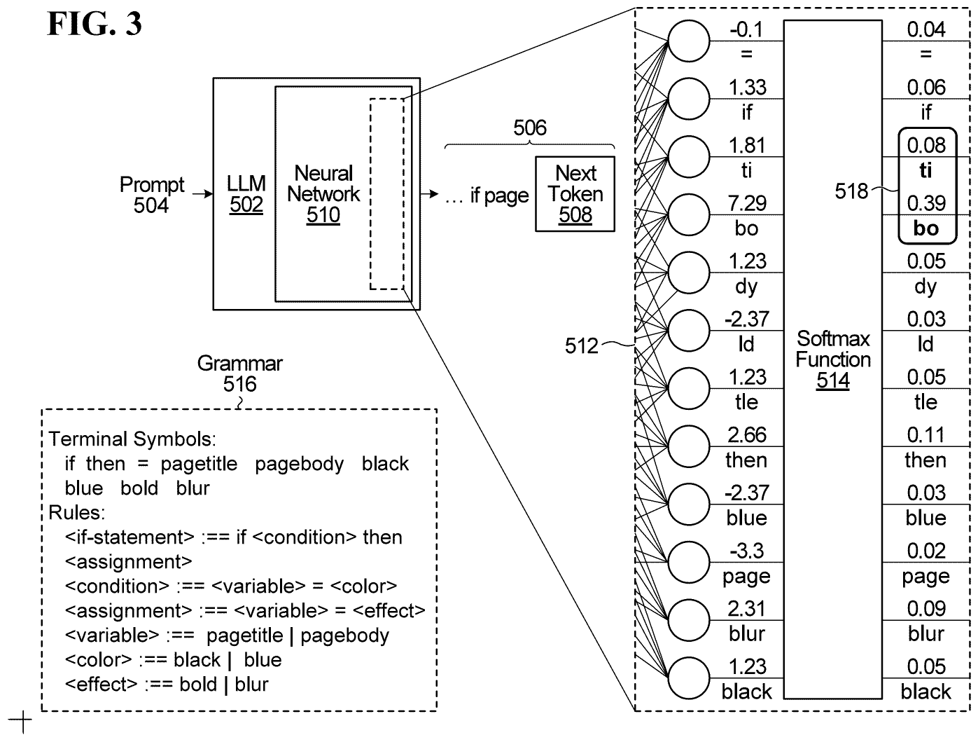

FIG. 3 illustrates an example of a generative language model generating a sequence of tokens. The generative language model is implemented as an LLM 502. The LLM 502 may have the example LLM structure described earlier in relation to FIG. 1B, or it may have another structure, e.g. it may only implement a decoder or an encoder, rather than both. The exact structure of the LLM 502 is implementation specific, although in the example of FIG. 3 it is assumed that the LLM 502 has at least one neural network. For ease of explanation, the example illustrated in relation to FIG. 3 will assume that LLM 502 is the LLM introduced above that can only generate the following tokens: =if ti bo dy ld tle then blue page blur black. As mentioned above, this is a simplified example for ease of explanation. In actuality, the LLM 502 may generate thousands of different tokens or more.

The LLM 502 receives a prompt 504 and in response generates a sequence of tokens 506. In generating the sequence of tokens, the LLM 502 needs to generate a next token 508 given one or more preceding tokens already generated. In the illustrated example, the LLM 502 has already generated a sequence with the immediately preceding tokens being “if page”. The LLM 502 determines what is the next token 508 given one or more preceding tokens, e.g. given “if page”. The LLM 502 includes one or more neural networks, although only one is illustrated as neural network 510. As shown in stippled box 512, the neural network 510 includes a layer in which there is a respective node corresponding to each possible next token that may be output by the LLM 502. The output from each node is indicative of a probability of the respective token being the next token 508. The value output from each node may be a number representing an unnormalized probability, as is the case in the illustrated example. The value output from each node may be a log it value. The plurality of values output from the layer of nodes may be or form a tensor, e.g. a tensor of log it values. In the example, a smaller number means a lower probability that the token is a next token. For example, the node corresponding to the token “page” outputs the number −3.3, meaning a low probability that “page” is the next token, whereas the node corresponding to the token “bo” outputs the number 7.29, meaning a high probability that “bo” is the next token. In the illustrated example, the output of the layer is input into a softmax function 514 that maps/scales the numbers into a probability between 0 and 1. The next token 508 is selected as one of the tokens typically having a high or highest probability of being the next token. The illustrated example assumes the grammar introduced earlier, which is illustrated as grammar 516. Note that there are tokens that may be selected as the next token 508 that would result in a sequence that is not compliant with the grammar 516. For example, the token “then” also has a relatively high probability of being the next token (probability of 0.11 in the example), but the sequence “if page then” would not be compliant with the grammar 516. That is, “if page then” is not a valid sequence defined by the grammar 516. In this example, the only tokens that are valid next tokens in terms of maintaining a grammar-compliant sequence are “ti” and “bo”, as shown at 518.

The generative language model (illustrated as LLM 502 in the example of FIG. 3) may be modified to always generate a next token that is grammar-compliant. In one example, the generative language model generates a plurality of values, each of the values indicative of a probability of a respective token being a next token. A mask is then applied to the plurality of values in the generative language model. The mask operates on each value that corresponds to a token not compliant with the grammar to reduce or zero the probability of that token being the next token. The next token is then determined based on the plurality of values after the mask is applied. As a result, the generative language model will only output a next token that maintains the grammar compliance of the sequence being generated. This process repeats for each next token in the sequence, with the mask being updated based on the grammar for generation of each next token.

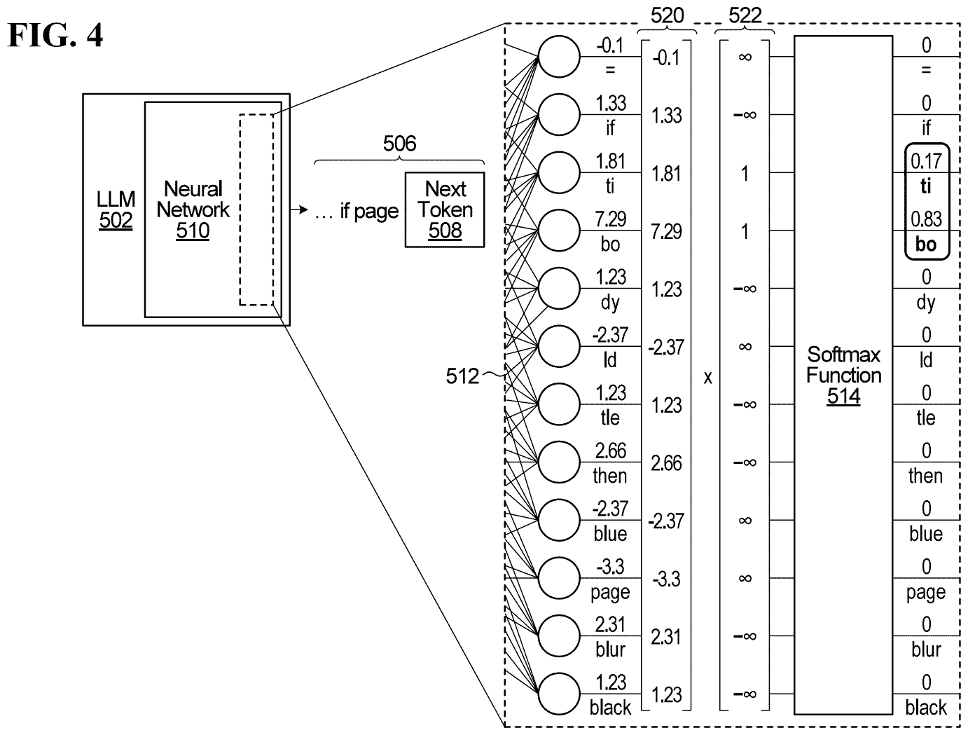

One example of applying the mask is illustrated in FIG. 4, using the example introduced in FIG. 3. The layer of neural network 510 having the plurality of nodes corresponding to each possible token being a next token outputs a tensor 520. The plurality of values in the tensor 520 are the unnormalized probabilities referred to above in FIG. 3 and may be log it values. The tensor may be a 1-D tensor or a vector, as is the case in the illustrated example. Prior to the softmax function 514, a mask 522 in the form of a second tensor 522 is applied to the tensor 520 by performing a tensor product. The application of the mask 522 may be considered an additional or final layer in the neural network 510 prior to the softmax function 514. For example, application of the mask 522 may be a transformation (e.g. GPU-based transformation) as a final layer of the LLM 502. The mask 522 includes the identity element at each position in the tensor 522 that corresponds to a valid next token. At each position in the tensor 522 that corresponds to an invalid next token (in terms of conforming to the grammar), there is a masking value that in this example is a number of a very large magnitude (shown as infinity) and appropriate sign to make the corresponding value in the first tensor 520 very small so that it effectively has an unnormalized probability of never being selected as the next token. The output of the tensor product (i.e. the output after applying the mask) is input into the softmax function 514, which generates a non-zero probability for selection of each possible valid next token, and otherwise maps the other values to a probability of zero (or effectively zero, e.g. a probability so close to zero it would effectively never be selected in operation). The LLM 502 will therefore only select “ti” or “bo” as the next token 508, which are the only two possible outputs that maintain the grammar compliance of the sequence.

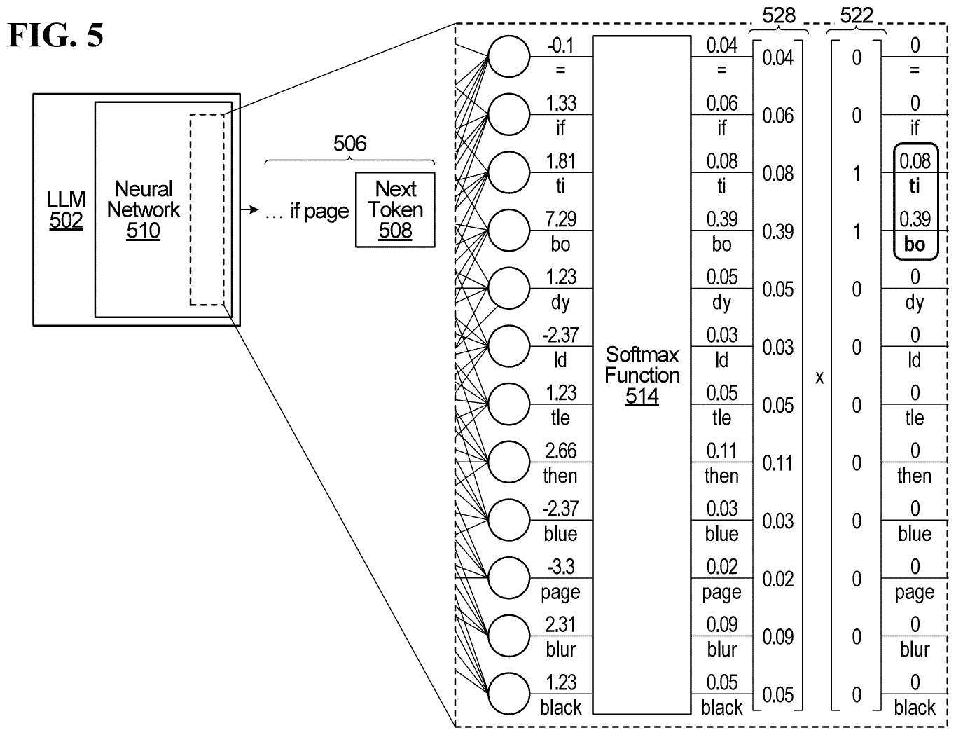

A variation of FIG. 4 is illustrated in FIG. 5 in which the mask 522 is instead applied to the output of the softmax function 514. In the example of FIG. 5, a mask 522 is applied to the vector 528 output by the softmax function 514 to zero out each position in the vector 528 corresponding to a token that will not maintain a grammar-compliant sequence. The mask 522 is a vector that has an identity element at each position corresponding to a valid token and has a zero at each other position, and the masking is applied by vector multiplication of vector 528 and mask 522. The LLM 502 will therefore only select “ti” or “bo” as the next token 508, which are the only two possible outputs that maintain the grammar compliance of the sequence.

For completeness, other example grammars are provided below.

Another example of a grammar may be a grammar that constrains the output to generation of a recipe have a particular format. For example, perhaps the recipe needs to be output in JSON and include an “Ingredients” section consisting of key-value pairs, where each pair names an ingredient and a quantity of that ingredient. An example of a valid sequence of output may be, for example: {“bananas”: “1”, “pears”: “2”, “cake mix”: “1”}. The grammar may define the following rules:

```
Rules:
  <number> :== [0-9]*
  <string> :== [\hat{ }<number>]*
  <ingredients> :== {“[string]”: “[number]”, “[string]”: “[number]”,
  “[string]”: “[number]”}
```

In this example grammar, [0-9] * means a sequence of numbers of any length, where each number is an integer between 0 and 9, and [\hat{ }<number>] * means a sequence of any characters of any length, but the characters must exclude numbers. In this example grammar the terminal symbols are not separately defined but are inherent from the rules themselves. The terminal symbols are the numbers and any valid symbols of a string (e.g. the letters of the alphabet) since these are allowed in the valid sequences of output defined by the rules of the grammar. Therefore, it will be understood that a grammar does not necessarily need to separately explicitly specify the terminal symbols, e.g. they may be inherent.

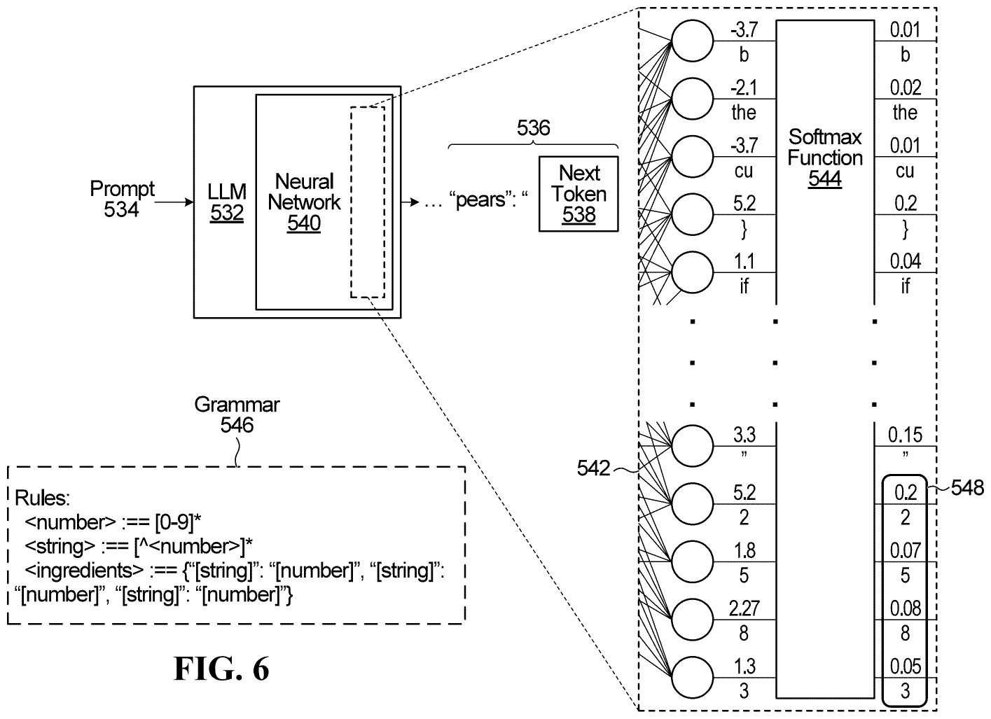

FIG. 6 illustrates an example of a generative language model generating a sequence of tokens. The generative language model is implemented as an LLM 532. The LLM 532 may have the example LLM structure described earlier in relation to FIG. 1B, or it may have another structure, e.g. it may only implement a decoder or an encoder, rather than both. The exact structure of the LLM 532 is implementation specific, although in the example of FIG. 3 it is assumed that the LLM 532 has at least one neural network.

The LLM 532 receives a prompt 534 and in response generates a sequence of tokens 536. In generating the sequence of tokens, the LLM 532 needs to generate a next token 538 given one or more preceding tokens already generated. In the illustrated example, the LLM 532 has already generated a sequence with the immediately preceding portion of the sequence being “pears”: “. The LLM 532 determines what is the next token 538 given one or more preceding tokens, e.g. given the immediately preceding portion of the sequence “pears”: “. The LLM 532 includes one or more neural networks, although only one is illustrated as neural network 540. As shown in stippled box 542, the neural network 540 includes a layer in which there is a respective node corresponding to each possible next token that may be output by the LLM 532. The output from each node is indicative of a probability of the respective token being the next token 538. The value output from each node may be a number representing an unnormalized probability, as is the case in the illustrated example. The value output from each node may be a log it value. The plurality of values output from the layer of nodes may be or form a tensor, e.g. a tensor of log it values. In the example, a smaller number means a lower probability that the token is a next token. For example, the node corresponding to the token “b” outputs the number −3.7, meaning a low probability that “b” is the next token, whereas the node corresponding to the token} outputs the number 5.2, meaning a high probability that} is the next token. In the illustrated example, the output of the layer is input into a softmax function 544 that maps/scales the numbers into a probability between 0 and 1. The next token 538 is selected as one of the tokens typically having a high or highest probability of being the next token. The illustrated example assumes the grammar introduced above, which is illustrated as grammar 546. Note that there are tokens that may be selected as the next token 538 that would result in a sequence that is not compliant with the grammar 546. For example, the token} also has a relatively high probability of being the next token (probability of 0.2 in the example), but the sequence “pears”: “} would not be compliant with the grammar 546. That is, “pears”: “} is not a valid output sequence defined by the grammar 546. In this example, the only tokens that are valid next tokens in terms of maintaining a grammar-compliant sequence are the tokens that are numbers, e.g. 2, 5, 8, or 3, as shown at 548.

The generative language model (illustrated as LLM 532 in the example of FIG. 6) may be modified to always generate a next token that is grammar-compliant. In one example, the generative language model generates a plurality of values, each of the values indicative of a probability of a respective token being a next token. A mask is then applied to the plurality of values in the generative language model. The mask operates on each value that corresponds to a token not compliant with the grammar to reduce or zero the probability of that token being the next token. The next token is then determined based on the plurality of values after the mask is applied. As a result, the generative language model will only output a next token that maintains the grammar compliance of the sequence being generated. This process repeats for each next token in the sequence, with the mask being updated based on the grammar for generation of each next token.

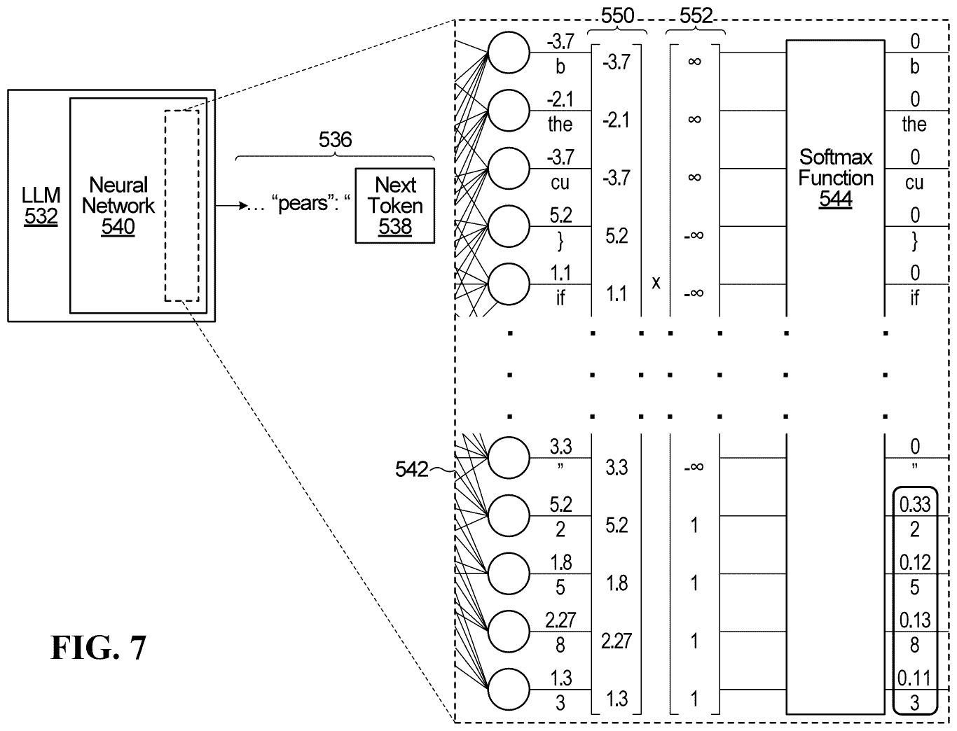

An example of applying the mask is illustrated in FIG. 7, using the example introduced in FIG. 6. The layer of neural network 540 having the plurality of nodes corresponding to each possible token being a next token outputs a tensor 550. The plurality of values in the tensor 550 are the unnormalized probabilities referred to above in FIG. 6 and may be log it values. The tensor may be a 1-D tensor or a vector, as is the case in the illustrated example. Prior to the softmax function 544, a mask 552 in the form of a second tensor 552 is applied to the tensor 550 by performing a tensor product. The application of the mask 552 may be considered an additional or final layer in the neural network 540 prior to the softmax function 544. For example, application of the mask 552 may be a transformation (e.g. GPU-based transformation) as a final layer of the LLM 532. The mask 552 includes the identity element at each position in the tensor 552 that corresponds to a valid next token. At each position in the tensor 552 that corresponds to an invalid next token (in terms of conforming to the grammar 546), there is a masking value that in this example is a number of a very large magnitude (shown as infinity) and appropriate sign to make the corresponding value in the first tensor 550 very small so that it effectively has an unnormalized probability of never being selected as the next token. The output of the tensor product (i.e. the output after applying the mask) is input into the softmax function 544, which generates a non-zero probability for selection of each possible valid next token, and otherwise maps the other values to a probability of zero (or effectively zero, e.g. a probability so close to zero it would effectively never be selected in operation). The LLM 532 will therefore only select a number as the next token 538, which is the only token output that maintains the grammar compliance of the sequence.

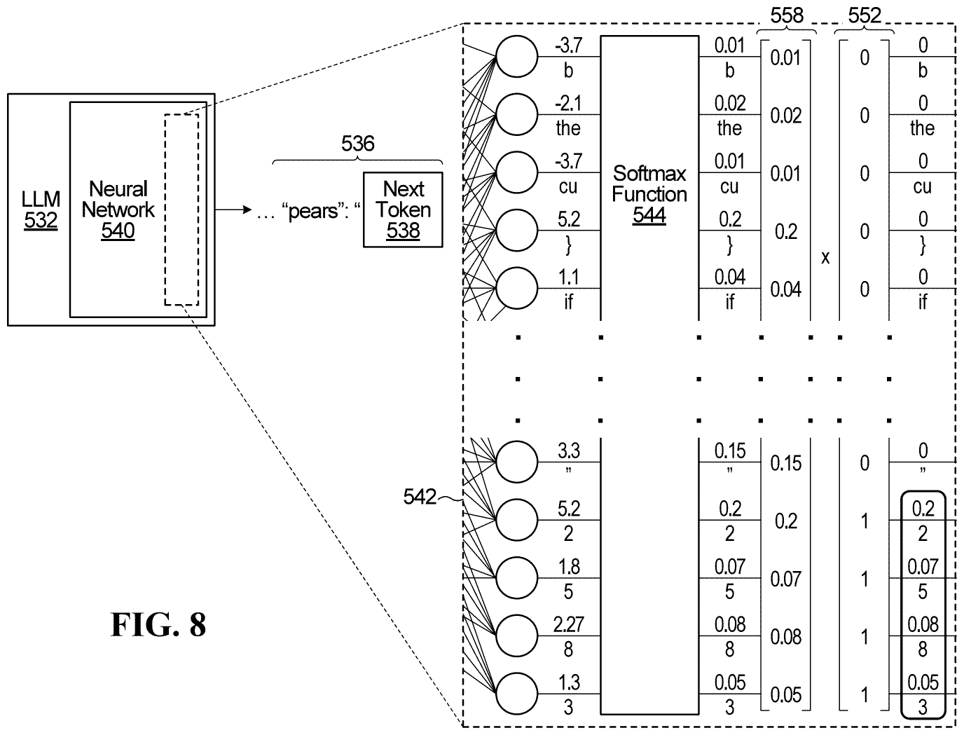

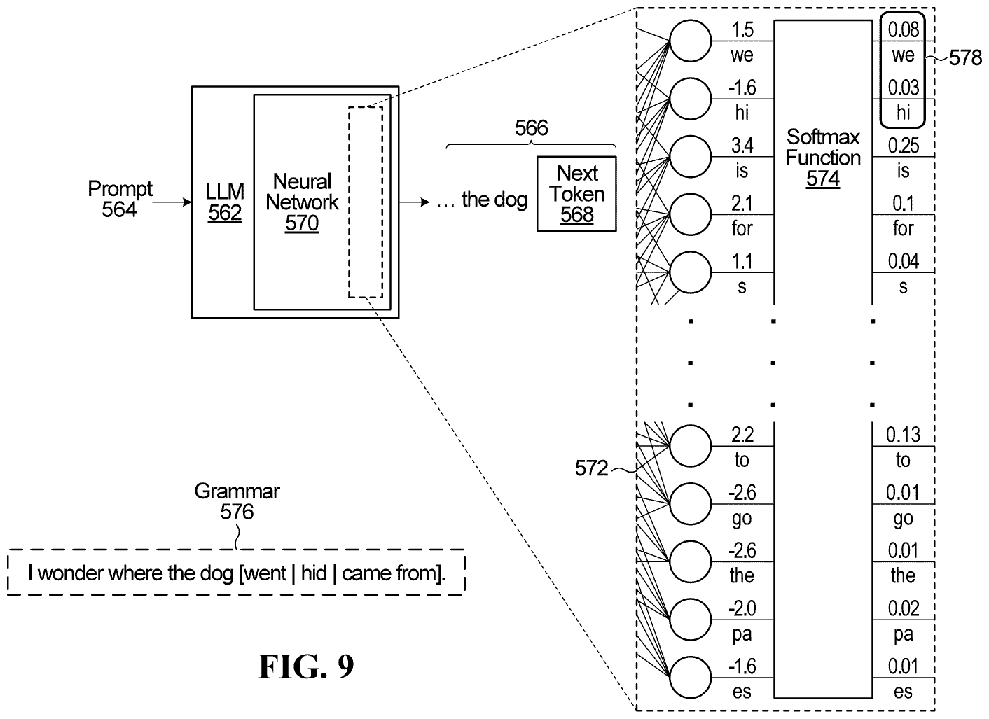

A variation of FIG. 7 is illustrated in FIG. 8 in which the mask 552 is instead applied to the output of the softmax function 544. In the example of FIG. 9, a mask 552 is applied to the vector 558 output by the softmax function 544 to zero out each position in the vector 558 corresponding to a token that will not maintain a grammar-compliant sequence. The mask 552 is a vector that has an identity element at each position corresponding to a valid token and has a zero at each other position, and the masking is applied by vector multiplication of vector 558 and mask 552. The LLM 532 will therefore only select a number as the next token 538, which is the only token output that maintains the grammar compliance of the sequence.

The two example grammars above are in the context of the generative language model outputting programming language code (where “programming language code”, as used herein, is broad enough to encompass data interchange (or exchange) language, markup language, or the like). The methods and systems disclosed herein are not limited to scenarios in which the generative language model is outputting programming language code. For example, the generative language model may be generating text meant to be read by a human. A grammar may be used to constrain the output of the generative language model as described herein. For example, perhaps the grammar is or includes the following rule: “I wonder where the dog [went | hid | came from].” That is, the generative language model must output a sentence starting with “I wonder where the dog” and ending with one of: “went” or “hid” or “came from”. An example of a valid output sequence (compliant with the grammar) would be: I wonder where the dog hid. An example of an invalid output sequence (not compliant with the grammar) would be: I wonder where the dog is today. In this example grammar the terminal symbols are not separately defined but are inherent, e.g. they may be any letter, number, or punctuation mark. Alternatively, the terminal symbols might be explicitly defined in the grammar. The rule is inherent by the restriction in the grammar that an output must be or include: I wonder where the dog [went | hid | came from]. That is, the rule is that the sentence must start with “I wonder where the dog” and end with “went” or “hid” or “came from”.

FIG. 9 illustrates an example of a generative language model generating a sequence of tokens. The generative language model is implemented as an LLM 562. The LLM 562 may have the example LLM structure described earlier in relation to FIG. 1B, or it may have another structure, e.g. it may only implement a decoder or an encoder, rather than both. The exact structure of the LLM 562 is implementation specific, although in the example of FIG. 3 it is assumed that the LLM 562 has at least one neural network.

The LLM 562 receives a prompt 564 and in response generates a sequence of tokens 566. In generating the sequence of tokens, the LLM 562 needs to generate a next token 568 given one or more preceding tokens already generated. In the illustrated example, the LLM 562 has already generated a sequence with the immediately preceding portion of the sequence being: the dog. The LLM 562 determines what is the next token 568 given one or more preceding tokens, e.g. given the immediately preceding portion of the sequence: the dog. The LLM 562 includes one or more neural networks, although only one is illustrated as neural network 570. As shown in stippled box 572, the neural network 570 includes a layer in which there is a respective node corresponding to each possible next token that may be output by the LLM 562. The output from each node is indicative of a probability of the respective token being the next token 568. The value output from each node may be a number representing an unnormalized probability, as is the case in the illustrated example. The value output from each node may be a log it value. The plurality of values output from the layer of nodes may be or form a tensor, e.g. a tensor of log it values. In the example, a smaller number means a lower probability that the token is a next token. For example, the node corresponding to the token “the” outputs the number −2.6, meaning a low probability that “the” is the next token, whereas the node corresponding to the token “is” outputs the number 3.4, meaning a high probability that “is” is the next token. In the illustrated example, the output of the layer is input into a softmax function 574 that maps/scales the numbers into a probability between 0 and 1. The next token 568 is selected as one of the tokens typically having a high or highest probability of being the next token. The illustrated example assumes the grammar introduced above, which is illustrated as grammar 576. Note that there are tokens that may be selected as the next token 568 that would result in a sequence that is not compliant with the grammar 576. For example, the token “is” has a high probability of being the next token (probability of 0.25 in the example), but the sequence “I wonder where the dog is” would not be compliant with the grammar 576. That is, “I wonder where the dog is” is not a valid output sequence defined by the grammar 576. In this example, the only tokens that are valid next tokens in terms of maintaining a grammar-compliant sequence are the tokens that equal to or are the start of the word “went”, “hid”, or “came”. For the illustrated tokens in FIG. 6, these are the tokens “we” and “hi”, as shown at 578.

The generative language model (illustrated as LLM 562 in the example of FIG. 9) may be modified to always generate a next token that is grammar-compliant. In one example, the generative language model generates a plurality of values, each of the values indicative of a probability of a respective token being a next token. A mask is then applied to the plurality of values in the generative language model. The mask operates on each value that corresponds to a token not compliant with the grammar to reduce or zero the probability of that token being the next token. The next token is then determined based on the plurality of values after the mask is applied. As a result, the generative language model will only output a next token that maintains the grammar compliance of the sequence being generated. This process repeats for each next token in the sequence, with the mask being updated based on the grammar for generation of each next token.

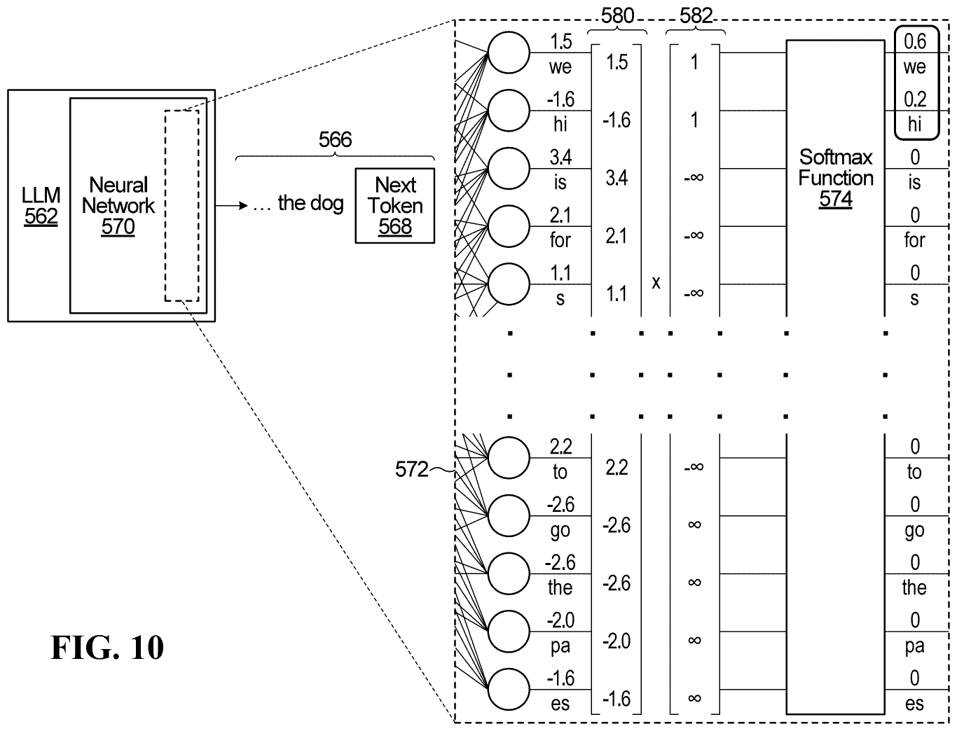

An example of applying the mask is illustrated in FIG. 10, using the example introduced in FIG. 9. The layer of neural network 570 having the plurality of nodes corresponding to each possible token being a next token outputs a tensor 580. The plurality of values in the tensor 580 are the unnormalized probabilities referred to above in FIG. 9 and may be log it values. The tensor may be a 1-D tensor or a vector, as is the case in the illustrated example. Prior to the softmax function 574, a mask 582 in the form of a second tensor 582 is applied to the tensor 580 by performing a tensor product. The application of the mask 582 may be considered an additional or final layer in the neural network 570 prior to the softmax function 574. For example, application of the mask 582 may be a transformation (e.g. GPU-based transformation) as a final layer of the LLM 562. The mask 582 includes the identity element at each position in the tensor 582 that corresponds to a valid next token. At each position in the tensor 582 that corresponds to an invalid next token (in terms of conforming to the grammar 576), there is a masking value that in this example is a number of a very large magnitude (shown as infinity) and appropriate sign to make the corresponding value in the first tensor 580 very small so that it effectively has an unnormalized probability of never being selected as the next token. The output of the tensor product (i.e. the output after applying the mask) is input into the softmax function 574, which generates a non-zero probability for selection of each possible valid next token, and otherwise maps the other values to a probability of zero (or effectively zero, e.g. a probability so close to zero it would effectively never be selected in operation). The LLM 562 will therefore only select a next token that maintains the grammar compliance of the sequence.

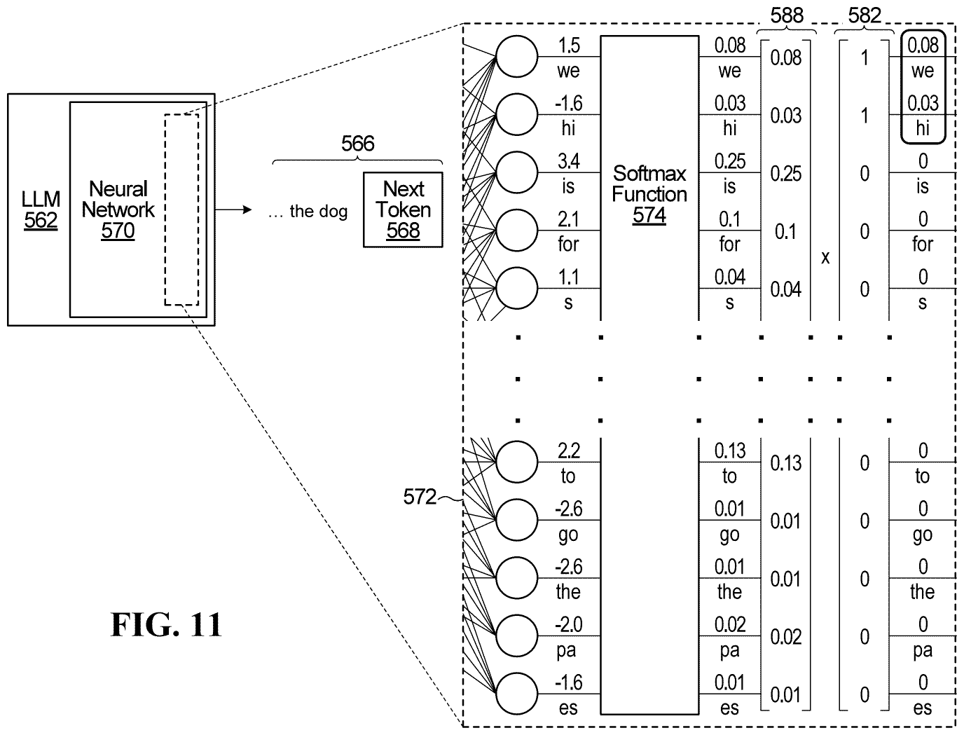

A variation of FIG. 10 is illustrated in FIG. 11 in which the mask 582 is instead applied to the output of the softmax function 574. In the example of FIG. 11, a mask 582 is applied to the vector 588 output by the softmax function 574 to zero out each position in the vector 588 corresponding to a token that will not maintain a grammar-compliant sequence. The mask 582 is a vector that has an identity element at each position corresponding to a valid token and has a zero at each other position, and the masking is applied by vector multiplication of vector 588 and mask 582. The LLM 562 will therefore only select a next token that maintains the grammar compliance of the sequence.

Note that in the example in FIGS. 9 to 11, the token “is” has a much higher probability than “we” or “hi” of being selected before the token selection is constrained by the grammar 576. Therefore, without the grammar 576 constraining the token selection, the LLM 562 would more likely select “is” as the next token in the sequence. However, because the grammar 576 constrains the token selection, “is” will never be output from the LLM 562 as the next token because its probability of being selected is reduced to zero. In general, in the methods and systems herein, the grammar constrains the selection of the next token to only those tokens that are valid next tokens (in terms of maintaining a valid output sequence as defined by the grammar), regardless of whether those tokens had a high probability of being selected absent the grammar.

The example grammars introduced above are simplified for ease of explanation. Grammars actually used in implementation may have many more terminal symbols, non-terminal symbols, and/or rules. However, the same principles discussed above and herein equally apply. Also, a grammar need not necessarily have terminal symbols, non-terminal symbols, and rules, but may instead be defined in another way, e.g. other ways known in the art.

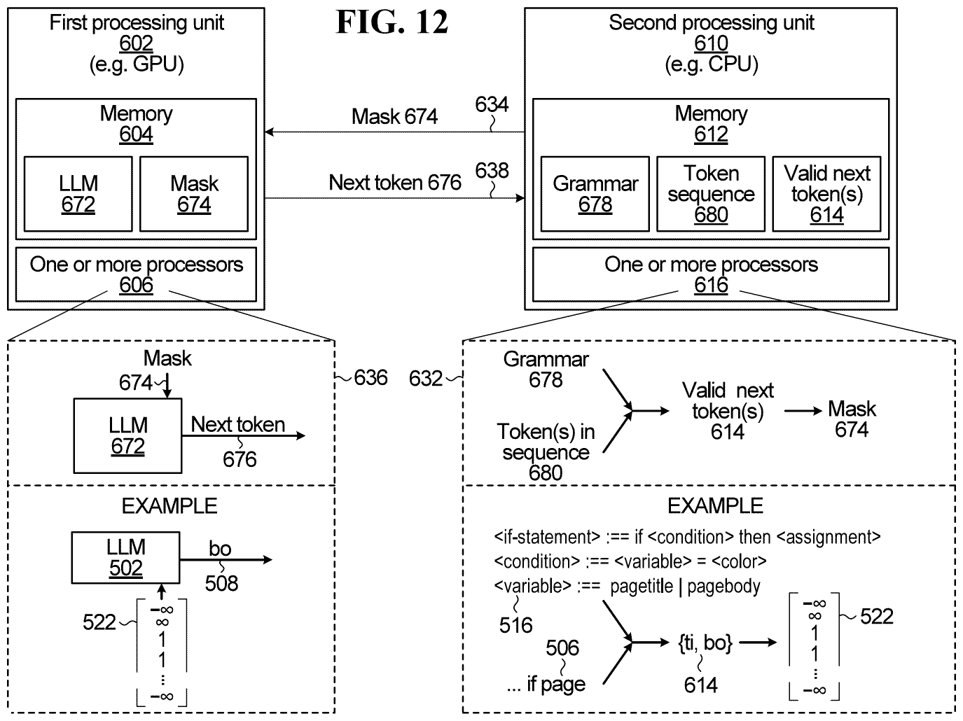

FIG. 12 illustrates a system for constraining an output of a generative language model using a grammar, according to one implementation. In the example system of FIG. 12, it is assumed that the generative language model is implemented using a first processing unit 602. The first processing unit 602 may be a specialized processing unit designed to accelerate computer operations, e.g. through parallelization of operations, which may allow for faster execution of the generative language model compared to a more general-purpose processing unit. For example, the first processing unit 602 may be a graphics processing unit (GPU) or a tensor processing unit (TPU) or a neural processing unit (NPU) or a hardware accelerator. The first processing unit 602 may be specialized to perform certain mathematical operations more quickly than general purpose processors, e.g. the first processing unit 602 may be able to more quickly implement tensor products and other related computational operations performed by neural networks. The first processing unit 602 may include a memory 604 that stores information and computations performed by the first processing unit 602. The memory 604 stores the generative language model, which is illustrated as an LLM 672. By “storing” the generative language model, it is meant that the parameters and other values that make up the model and that are required for execution of the model are stored. The parameters depend upon how the generative language model is implemented. For example, assuming the generative language model utilizes one or more neural networks, the weights and biases of the one or more neural networks are stored.

Note that LLM 672 will be used in the explanation below as the generative language model. However, in general the generative language model need not be limited specifically to an LLM. Whenever “LLM” is used herein, it may instead be replaced with “generative language model”.

The memory 604 further stores a mask 674 to be applied in the LLM 672 for generation of the next token. The first processing unit 602 further includes one or more processors 606, which perform the operations of the first processing unit 602. For example, the one or more processors 606 execute the LLM 672 and apply the mask 674 to generate a grammar-compliant sequence of tokens in the manner explained herein. The one or more processors 606 may each be implemented as a processor that executes instructions stored in memory, or it/they may be or include dedicated integrated circuits, such as one or more field programmable gate arrays (FPGAs) and/or one or more application-specific integrated circuits (ASICs). The one or more processors 606 may be or include one or more processing cores. The one or more processors 606 may be or include one or more processing cores on a GPU.

The system of FIG. 12 further includes a different second processing unit 610. The first processing unit 602 and the second processing unit 610 may communicate with each other, e.g. over a network or bus (not illustrated), to send information to each other. In one example, the second processing unit 610 may send API requests (“API calls”) to the first processing unit 602 to send information to (e.g. send the mask 674 to) and receive information from (e.g. receive the next token 676 from) the first processing unit 602.

The second processing unit 610 may be a general-purpose processing unit that is not specialized, e.g. it may be a central processing unit (CPU) of a server or other computer. The second processing unit 610 may by a processor that executes instructions to perform the operations of the second processing unit 610. The second processing unit 610 might not directly execute intensive specialized computations like machine learning models, but may utilize such specialized electronic circuits, e.g. through API calls. For example, the second processing unit 610 may be a server or other computer serving a user. If the user makes a request that requires the LLM 672 to generate output, then the second processing unit 610 may communicate with the first processing unit 602 to instruct the first processing unit 602 to execute the LLM 672 to generate the output. The second processing unit 610 includes a memory 612 for storing information, values, and instructions needed and/or used by the second processing unit 610. In this example, the second processing unit 610 stores in memory 612 an indication of a grammar 678. The memory 612 also stores the sequence of tokens 680 returned from the LLM 672, where the sequence of tokens 680 is or forms the basis of the output generated by the LLM 672. In the example of FIG. 12, the second processing unit 610 has knowledge of the grammar 678 and therefore generates the mask 674 to be applied by the LLM 672 for each token generation iteration of the LLM 672. To generate the mask 674, the second processing unit 610 needs to determine the valid set of next token(s) given the grammar 678 and the token sequence 680 already generated by the LLM 672. The valid set of next token(s) 614 is stored in memory 612.

The second processing unit 610 further includes one or more processors 616, which perform the operations of the second processing unit 610. For example, the one or more processors 616 receive the already generated token sequence from the LLM 672, generate the mask 674 based on one or more previously generated tokens of the token sequence, and transmit the mask 674 back to the first processing unit 602 for use by the LLM 672 to generate the next token 676 in the sequence. The one or more processors 616 may each be implemented as a processor that executes instructions stored in memory, or they may be or include dedicated integrated circuits, such as one or more GPUs, FPGAs, and/or ASICs. The one or more processors 616 may be or include one or more processing cores. The one or more processors 616 may be or include one or more processing cores of a CPU.

The LLM 672 may, for example, be LLM 502 or LLM 532 or LLM 562 in the examples introduced. The mask 674 may, for example, be mask 522 or mask 552 or mask 582 in the examples introduced earlier. The next token 676 may, for example, be next token 508 or next token 538 or next token 568 in the examples introduced earlier. The grammar 678 may, for example, be the grammar 516 or the grammar 546 or the grammar 576 in the examples introduced earlier. The token sequence 680 may, for example, be the token sequence 506 or the token sequence 536 or the token sequence 566 in the examples introduced earlier.

FIG. 12 also illustrates operations performed by the one or more processors of each processing unit. As illustrated in stippled box 632, the one or more processors 616 of the second processing unit 610 generate a set of valid next tokens 614 based on the grammar 678 and the token sequence 680 already generated by the LLM 672, e.g. based on at least one preceding token in the token sequence. For example, assuming grammar 678 is the example grammar 516 introduced earlier, if the token sequence already generated is “ . . . if page”, then according to the grammar 516, a grammar-compliant symbol is “pagetitle” or “pagebody”, which means that the next valid tokens include “ti” and “bo”. These two tokens make up the set of valid next tokens 614. The one or more processors 616 then generate the mask 674 based on the set of valid next tokens 614, e.g. by including an identity element in each position in the mask 674 that corresponds to a valid next token, and otherwise putting a masking value in the other positions to act on the values in the LLM 672 that correspond to the other tokens. The mask 674 is then transmitted to the first processing unit 602, as shown at 634. An example is also illustrated in stippled box 632 in which the grammar 678 is assumed to be grammar 516 introduced earlier. The rules of the grammar 516 and the immediately preceding tokens in the sequence “ . . . if page”, are used to generate a set of valid tokens 614 {ti, bo}, which are used to generate the mask 522 illustrated in FIG. 4. The mask 522 is then transmitted to the first processing unit 602.

Turning now to stippled box 636, the LLM 672 then takes the mask 674 and applies it during the generation of the next token 676, such that the LLM 672 will only generate a next token 676 that maintains the grammar-compliance of the token sequence 680. The next token 676 is then transmitted to the second processing unit 610, as shown at 638. The second processing unit 610 then updates the stored token sequence 680 to append that next token 676 and then uses the updated token sequence 680 and the grammar 678 to generate a new set of valid next token(s) 614, to generate a new mask 674.

An example is illustrated in stippled box 636 in which the grammar 678 is assumed to be grammar 516 introduced earlier and the LLM 672 is assumed to be LLM 502 introduced earlier. The mask 522 from FIG. 4 is applied via a tensor product (as discussed in relation to FIG. 4), after which the LLM 502 generates a next token 508, which in the example is the token “bo”. The next token 508 is then transmitted to the second processing unit 610. The second processing unit 610 then updates the stored token sequence 506 to append that next token 508 and then uses the updated token sequence 506 and the grammar 516 to generate a new set of valid next token(s) 614, to generate a new mask 522. For example, given that the token sequence is now “ . . . if pagebo”, according to the grammar the only valid next token is “dy”, and so the updated mask 522 would act to cause the values not corresponding to token “dy” to have zero probability (or close to zero probability) of being selected. The updated mask 522 is then transmitted to the first processing unit 602 for use by the LLM 502 to generate the next token, and the process continues in this way until the LLM 502 reaches a stop condition and ends the token sequence, at which point the token sequence 506 is grammar-compliant programming language code.

In some implementations, a stop condition of LLM 672 may be controlled to ensure that the LLM 672 does not stop in the middle of a grammar rule, but rather stops at a point where the generated output is valid. One example way to achieve this may be to use the states/stacks discussed later and limit the stop condition to only being at one or more points where a valid stop has been reached (e.g. the rules of the grammar satisfied based on the state and/or empty stack, etc.). Another example is to tie the stop condition to generation of a terminal symbol that, according to the grammar, is associated with an end of an output.

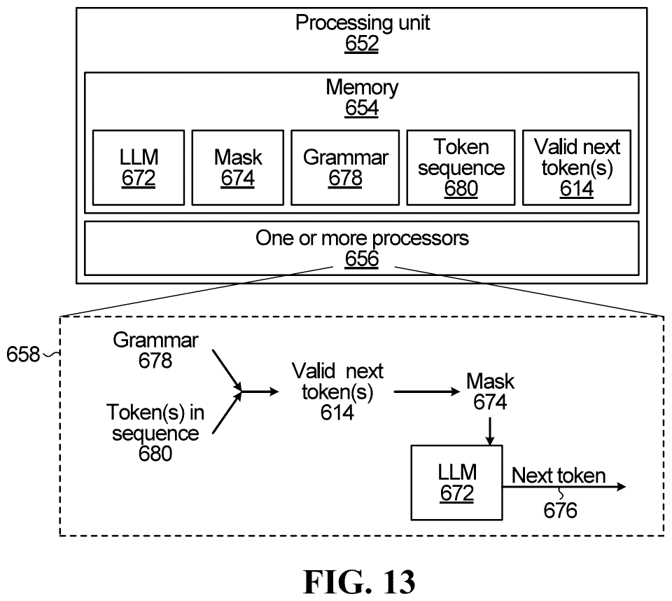

The use of two separate processing units in FIG. 12 is only one example implementation. In general, there may be one processing unit or multiple processing units that may work together. For example, FIG. 13 is the same as FIG. 12 except that everything is performed on a single processing unit 652, e.g. on a single server or other computer. The relevant information is stored in single memory 654 (which may be distributed), and a single set of one or more processors 656 performs the operations, e.g. the operations shown in stippled box 658 in which the grammar 678 and token(s) in the already generated sequence 680 are used to determine the set of valid next token(s) 614, which is then used to generate a mask 674, which is then applied to generation of the next token 676 in the LLM 672. In this example, there is not necessarily a specialized processing circuit (e.g. GPU) to implement the LLM 672, but instead all operations are performed by a same processing unit, which might be a general purpose processor. For example, processing unit 652 may be implemented by a processor that executes instructions stored in memory (e.g. in the memory 654). Alternatively, it may be or include dedicated integrated circuits, such as one or more GPUs, FPGAs, and/or ASICs. In some implementations, the processing unit 652 may be or include one or more processing cores, e.g. one or more processing cores of a CPU.

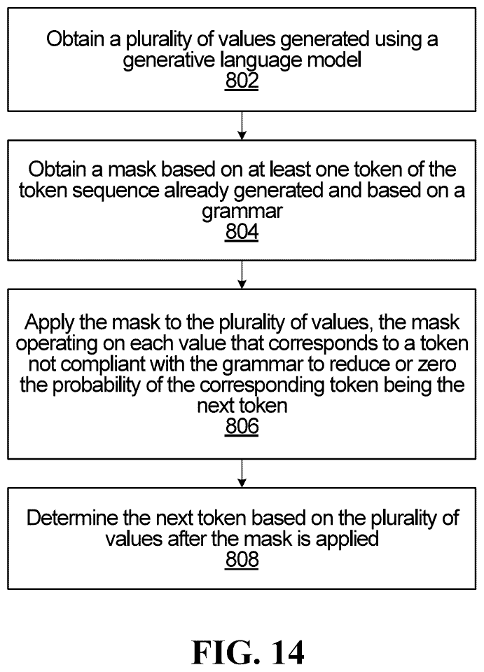

FIG. 14 illustrates a computer-implemented method, according to one aspect. The method may be performed by at least one processing unit, which might or might not be distributed. For example, the at least one processing unit may be processing unit 652, or it may be first processing unit 602, or it may be second processing unit 610, or it may be a combination of first processing unit 602 and second processing unit 610 working together like explained in relation to FIG. 12, etc.

At step 802, a plurality of values are obtained that are generated using a generative language model. Each of the values is indicative of a probability of a respective token being a next token in a token sequence generated by the generative language model. One example of the plurality of values is the tensor 520 of values illustrated in FIG. 4. Each of these values in the tensor 520 represents an unnormalized probability that a respective token corresponding to the value is the next token given one or more previously generated tokens of the sequence. Another example of the plurality of values is the vector 528 output from the softmax function 514. Each of these values in the vector 528 represents a normalized probability (i.e. between 0 and 1) that a respective token corresponding to the value is the next token given one or more previously generated tokens of the sequence. Tensor 550, vector 558, tensor 580, and vector 588 are each also an example of the plurality of values. Note, however, that the method of FIG. 14 is not limited to the examples of FIGS. 3 to 11. For example, the plurality of values may be generated somewhere else in the generative language model, e.g. in an earlier layer of the neural network than the layer shown in FIG. 4.

At step 804, a mask is obtained based on at least one token of the token sequence already generated by the generative language model and based on a grammar defining valid sequences of output. An example of the mask is mask 674 or mask 522 or mask 552 or mask 582 from the earlier examples. An example of the grammar is grammar 678 or grammar 516 or grammar 546 or grammar 576 from the earlier examples.

At step 806, the mask is applied to the plurality of values. The mask is applied in the generative language model before the generative language model determines the next token. The mask, when applied to the plurality of values, operates on each value that corresponds to a token not compliant with the grammar to reduce (e.g. close to zero) or zero the probability of the corresponding token being the next token. In some implementations, the probability may be reduced to “substantially zero”, meaning that it might not literally be zero (although it could be), but if not literally zero it would be close enough to zero that there would effectively be no chance of the token being selected as the next token. One example is the mask 522 of FIG. 4. In this example, the mask 522 is applied by performing a tensor product in the LLM 502. The tensor product operates on each value that corresponds to a token not compliant with the grammar 516 to cause the value to become very small (effectively negative infinity), which results in a probability of zero (or effectively zero, i.e. very small) such that the token will not be selected as the next token 508. Another example is the mask 522 of FIG. 5. In this example, the mask 522 is applied to zero the probability for each token that is not a valid next token. FIGS. 7, 8, 10, 11 and stippled box 636 of FIG. 12 show other examples of applying a mask.

Note that how the mask is applied in step 806 is not limited to the examples in FIGS. 4 to 12. As an example, applying the mask may not literally be implemented by multiplication. Instead, for example, the mask may be an operation of directly or indirectly modifying the values that correspond to tokens that are not grammar-compliant next tokens to reduce or zero their probability of being selected as the next token. The mask may be an operation that strips out or nulls the values (e.g. in the tensor or output from the softmax function) that correspond to tokens that are not grammar-compliant next tokens to reduce or zero their probability of being selected as the next token. The mask may be an instruction or operation to modify or remove the values (e.g. in the tensor or output from the softmax function) that correspond to tokens that are not grammar-compliant next tokens to reduce or zero their probability of being selected as the next token.

At step 808, the generative language model determines the next token based on the plurality of values after the mask is applied.

In some implementations, the method of FIG. 14 may further include obtaining the mask by determining a set of valid next tokens based on the at least one token of the token sequence already generated by the generative language model and based on the grammar. The set of valid next tokens consists of one or more tokens any one of which, when appended to the token sequence, results in the token sequence still being compliant with the grammar. That is, the set of valid next tokens consists only of token(s) any one of which, when appended to the token sequence already generated, maintains the grammar-compliance of that token sequence. An example is shown in FIGS. 12 and 13 in which a set of valid next token(s) 614 is generated from the grammar 678 and from one or more tokens in sequence 680 (e.g. based on the immediately preceding token(s)).

In some implementations, obtaining the mask may further include generating the mask by, for each token not in the set of valid next tokens, generating a corresponding masking value that, when applied, reduces or zeros the probability of the token being the next token. For example, in the example of FIG. 4 the only valid next tokens are “ti” or “bo”. Therefore, the mask 522 is generated by generating a corresponding masking value of magnitude “infinity” (very large magnitude) and appropriate sign at each position corresponding to a token not in the set of valid next tokens (i.e. corresponding to a token that is not “ti” or “bo” in the example). When the mask 522 is applied, the masking value operates on its corresponding value in the LLM to cause the token corresponding to that value to have a zero (or close to zero) probability of being selected as the next token 508. Note that in the example of FIG. 4 where the masking value needs to have the appropriate sign (+ or −), the sign might not be generated as part of the mask 522 because it might not be known which values are negative numbers versus positive numbers. In this situation, the mask might just have magnitude “infinity” (very large number) in each position corresponding to a token that is not a valid next token, and the generative language model applies the appropriate sign when performing the tensor product.

In some implementations of the method of FIG. 14, obtaining the plurality of values in step 802 may include or consist of generating a first tensor in a neural network of the generative language model, where the first tensor includes the plurality of values. An example is FIG. 4 in which the plurality of values are generated by generating tensor 520 in the neural network 510, the tensor 520 including the plurality of values. In some implementations, the mask may be a second tensor, e.g. tensor 522 of FIG. 4. In some implementations, applying the mask may include or be implemented by performing a tensor product of the first tensor and the second tensor. This is the case in the example of FIG. 4 in which a tensor product between 520 and 522 is performed, which involves, for each position in the tensor 520, multiplying the value with the value in the corresponding position in tensor 522. That is −0.1 is multiplied by infinity (very large number), 1.33 is multiplied by negative infinity (very large negative number), 1.81 is multiplied by 1, etc. In some implementations, at each position in the second tensor that corresponds to a valid next token there is an identity element that does not modify the value in the first tensor corresponding to the valid next token when the tensor product is performed. For example, in FIG. 4 at the positions in second tensor 522 corresponding to a valid next token (“ti” or “bo”) there is a value “1”, which does not modify the value in the first tensor 520 that corresponds to that valid next token when the tensor product is performed (e.g. when the tensor product is performed in FIG. 4, 1.81 is multiplied by 1 and 7.29 is multiplied by 1). In some implementations, at each position in the second tensor that corresponds to an invalid next token there is the corresponding masking value that does modify the value in the first tensor corresponding to the invalid next token when the tensor product is performed to reduce or zero the probability of the invalid next token being the next token. For example, in FIG. 4 at the positions in second tensor 522 corresponding to an invalid next token (i.e. all positions that correspond to a token other than “ti” or “bo”) there is a masking value having magnitude infinity (very large magnitude), which modifies the value in the first tensor 520 that corresponds to that invalid next token when the tensor product is performed. Note that an “invalid next token”, as used here, is a token not in the set of valid next tokens. That is, it is a token that, if appended to the token sequence, would cause the token sequence to no longer be grammar-compliant.

In some implementations of the method of FIG. 14, the application of the mask may be implemented as an additional or final layer in a neural network of the generative language model, e.g. possibly prior to the softmax function. For example, application of the mask may be a transformation (e.g. a GPU-based transformation) as a final layer of the generative language model.

In some implementations of the method of FIG. 14, rather than the plurality of values being values in a tensor output by the neural network (like in the FIG. 4 example), the plurality of values may be a plurality of normalized probability values. For example, the plurality of values may be the output from a softmax function of the generative language model. In this example, applying the mask may involve reducing or setting to zero probability each of the normalized probability values that corresponds to a token not compliant with the grammar. An example is described earlier in relation to FIG. 5 in which the plurality of values is vector 528 output from softmax function 514, and the mask is applied by multiplying vector 528 by vector 522.

In some implementations of the method of FIG. 14, the plurality of values need not be in a tensor (e.g. tensor 520) or in a vector (e.g. vector 528) at or after the final layer of the neural network, but might instead be values generated at some other point in the generative language model, e.g. in an earlier layer of a neural network.

In some implementations of the method of FIG. 14, different processing units may be involved in performing different steps. For example, generating the plurality of values using the generative language model and the applying the mask may be implemented on a first processing unit, as is the case in the example of FIG. 12. As another example, the determining the set of valid next tokens and the generating the mask may be implemented on a second processing unit, as is also the case in the example of FIG. 12. For example, the first processing unit may be a specialized processing unit, such as a GPU, and the second processing unit may be a general purpose processor, such as a CPU. In some implementations, the method of FIG. 14 may include transmitting the mask from the second processing unit to the first processing unit, e.g. like at step 634 in the example of FIG. 12. The method may also include transmitting the next token from the first processing unit to the second processing unit (e.g. like at step 638 in the example of FIG. 12), where the next token was generated after the mask was applied. In some implementations, it may be that none of the plurality of values is transmitted from the first processing unit to the second processing unit, as is the case in the example in FIG. 12 in which the next token 676 is transmitted from the first processing unit 602 to the second processing unit 610 (at step 638), rather than any of the plurality of values generated by the LLM 672 being transmitted. For example, a tensor of values (e.g. tensor 520) or even a subset of that tensor, does not needed to transmitted from the first processing unit 602 to the second processing unit 610. Rather, the next token 676 is transmitted from the first processing unit 602 to the second processing unit 610. In other implementations, one or some of the plurality of values might also or instead be transmitted from the first processing unit 602 to the second processing unit 610, e.g. instead of or in addition to the next token 676. As one example, for the token determined to be the most probable next token, the corresponding value indicative of its probability of being the next token may be transmitted from the first processing unit 602 to the second processing unit 610. As another example, for a set of tokens determined to each have a high probability of being the next token (e.g. the top ten most probable next tokens), the corresponding set of values indicative of their probability may be transmitted from the first processing unit 602 to the second processing unit 610. The second processing unit 610 might then select the next token 676 from the set, rather than the LLM 672.

In some implementations of the method of FIG. 14, an immediately preceding token of the token sequence is a first portion of a terminal symbol of the grammar, and the set of valid next tokens includes a next portion of the terminal symbol. An example is illustrated in stippled box 632 of FIG. 12. In this example, the immediately preceding token of the token sequence 506 is “page”. The set of valid next tokens 614 is “ti” and “bo”. Note that “ti” and “bo” are both next portions of a valid terminal symbol. Specifically, the valid terminal symbols in this situation according to the grammar 516 are “pagetitle” and “pagebody”, which both start with “page”. This means that “ti” is a next portion of the valid terminal symbol “pagetitle”, and “bo” is a next portion of the valid terminal symbol “pagebody”.

In some implementations of the method of FIG. 14, based on the token sequence already generated by the generative language model and based on the one or more rules of the grammar, there are multiple possible terminal symbols of the grammar that can be generated by the generative language model that are compliant with the grammar. The set of valid next tokens therefore includes tokens each of which is a portion of or equal to one of the multiple possible terminal symbols. An example again is illustrated in stippled box 632 of FIG. 12. In this example, based on the token sequence 506 already generated (“ . . . if page”), there are multiple possible terminal symbols that can be generated: “pagetitle” or “pagebody”. Both are compliant with the grammar 516. Therefore, the set of valid next tokens includes tokens that are a portion of one of these multiple possible terminal symbols. Specifically, in the example, the set of valid next tokens 614 includes “ti” (which is a portion of the terminal symbol “pagetitle”) and also includes “bo” (which is a portion of the terminal symbol “pagebody”).

In some implementations of the method of FIG. 14, the set of valid next tokens and mask may be generated by determining, based on the previously generated token sequence and the grammar, which possible next tokens are valid, i.e. which possible next tokens would maintain a grammar-compliant sequence if appended to the already-existing token sequence. One way to determine the set of valid next tokens is to perform parsing of the sequence of tokens already generated, determine a current state and the possible next states, and for each possible next state determine which tokens are valid next tokens. In some implementations, a method analogous to or following Look-Ahead, Left-to-right, Rightmost Derivation (LALR) parsing or Left-to-right, Leftmost derivation (LL) parsing or Left-to-right, Rightmost derivation in reverse (LR) parsing may be implemented. These parsing methods and others are described, for example, in “Compilers: Principles, Techniques, and Tools” Second Edition by Alfred V. Aho, Monica S. Lam, Ravi Sethi, and Jeffrey D. Ullman, published in 2006 by Pearson Education, Inc., ISBN 0-201-10088-6, which is incorporated herein by reference.

In one example implementation, assuming the example introduced in FIGS. 3 to 5, given the token sequence “ . . . if page”, there are two possible next states according to the grammar 516: one in which the terminal symbol will be “pagetitle” and one in which the terminal symbol will be “pagebody”. A stack may be implemented for each future possible state:

| | |
|---|---|
| (stack 1) | (stack 2) |
| pagetitle | pagebody |
| if | if |

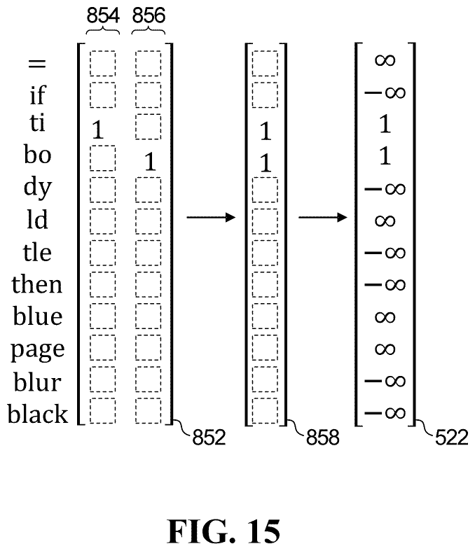

To have a valid state corresponding to stack 1, the next token must be “ti”. To have a valid state corresponding to stack 2, the next token must be “bo”. The mask may then be generated based on the set of valid next tokens, which in this example is the set of tokens {ti, bo}. In some implementations, to generate the mask a matrix may be generated where each column corresponds to a possible next valid state, and each row corresponds to a respective different possible token output from the generative language model, and for each column an identity element (e.g. value of ‘1’) is inserted at the location of the valid token corresponding to that state. The matrix may then be collapsed into the mask, e.g. into a tensor vector to be applied as a mask. FIG. 15 illustrates this specific example implementation of mask generation for the example grammar 516 and LLM 502 described in relation to FIGS. 3 to 5. Given the sequence “ . . . if page”, there are two possible next states according to the grammar 516: one in which the terminal symbol will be “pagetitle” and one in which the terminal symbol will be “pagebody”. A matrix 852 is generated where each column corresponds to a possible next valid state. In this example, column 854 corresponds to the possible valid next state in which the terminal symbol is “pagetitle” (and therefore the next valid symbol is “ti”), and column 856 corresponds to the alternative possible valid next state in which the terminal symbol is “pagebody” (and therefore the next valid symbol is “bo”). Each row of the matrix 852 corresponds to a respective different possible token output from the LLM 502, and for each column the value of ‘1’ is inserted at the location of the valid token corresponding to that state. The matrix 852 is then collapsed into a vector 858, and the appropriate masking values added at the locations where there is not a ‘1″ to result in mask 522. This is an example way in which a mask may be generated given a grammar and the previously generated tokens of the token sequence. Although this example way is explained having regard to the grammar of FIGS. 3 to 5, the explanation applies to any grammar.

If a stack (or stacks) are implemented, e.g. in the manner described above, then items (e.g. terminal symbols of the grammar) may be pushed on and popped off each stack, as necessary, e.g. when the state machine changes states. For example, when the generative language model generates a next token that eliminates one of the possible valid states, the stack associated with that state may be deleted. Continuing the example above, if the next token output from the LLM 502 is “bo” (as is the case in the example in stippled box 636 of FIG. 12), then there is only one valid state (associated with stack 2), and stack 1 may be deleted. A stack may also grow and shrink as the tokens are generated and the state machine moves from one valid state to the next, e.g. the stack shrinks down to zero when a rule of the grammar has been satisfied. In some implementations of the method of FIG. 14, the generative language model may have a stop-condition that is linked to all rules of the grammar being satisfied, e.g. the generative language model cannot finish the sequence of output if the state of the stack is indicative of a rule of the grammar not yet satisfied. Additionally or alternatively, in some implementations of the method of FIG. 14, the generative language model may have a stop-condition that is linked to a particular terminal symbol that can validly end a sequence of output.

In some implementations of the method of FIG. 14, the set of valid next tokens 614 may be generated by determining, for each token of a plurality of tokens, whether that token is a valid next token, in which case it forms part of the set of valid next tokens. For example, continuing the example of stippled box 632 of FIG. 12, based on the token sequence already generated 506 (“ . . . if page”) and based on one or more rules of the grammar 516, it is determined that the valid possible terminal symbols are “pagetitle” and “pagebody”. This means that a valid next token is any token that can be generated by the LLM that starts with “t” or “b” and that forms the first portion (or all) of the word “title” or “body”. For example, a valid next output of the LLM 502 could be “t” or “ti” or “tit” or “titl” or “title” or “b” or “bo” or “bod” or “body”. However, not all of these options are necessarily part of the tokenization of the LLM 502, e.g. in the example introduced in relation to FIGS. 3 to 5 the LLM 502 can only produce one of the following tokens: =if ti bo dy ld tle then blue page blur black. In one implementation, to determine the set of valid next tokens 614, the at least one processing unit (e.g. the second processing unit 610 in the example of FIG. 12) compares every token that can be generated by the LLM to the set of possible valid next outputs given the token sequence already generated and given the grammar. In the example, each element of the set {=if ti bo dy ld tle then blue page blur black} (i.e. each possible token that can be generated by the LLM 502) is checked to see if it equals one of the valid next outputs, which in this example is the set {t ti tit titl title b bo bod body}. The comparison reveals that the tokens “ti” and “bo” are valid next tokens. These tokens form the set of valid next tokens 614.

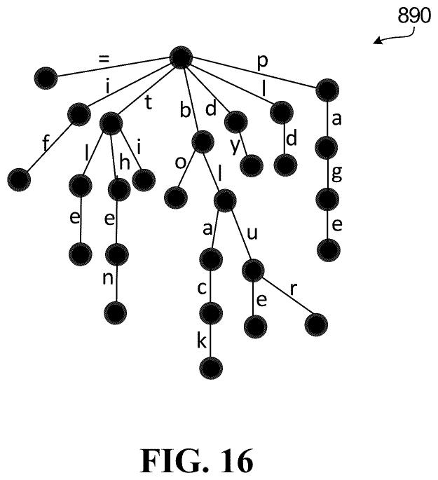

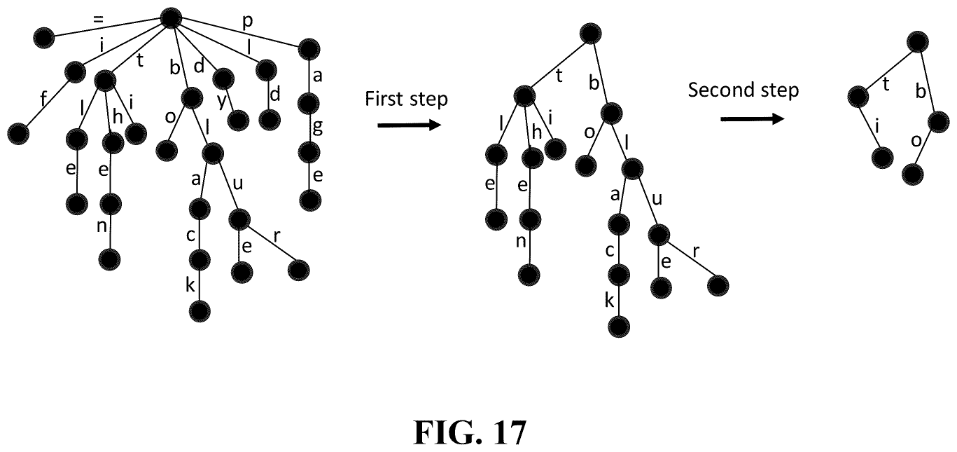

In some implementations, optimizations may be applied to reduce the number of comparisons when determining the set of valid next tokens. In one example, all possible tokens that can be generated by the generative language model are stored in the form of a tree, e.g. a trie. The tree may be implemented in a variety of ways, e.g. a naive trie, or a radix tr (i/e) e, or a Practical Algorithm to Retrieve Information Coded in Alphanumeric (PATRICIA) tree, etc. The tree may be constructed without having regard to the grammar. For example, FIG. 16 illustrates one example of a trie 890 for the LLM 502 of the example introduced earlier in relation to FIGS. 3 to 5. The trie 890 represents the set of valid tokens that may be output by the LLM 502, where common prefixes are stored once. To avoid having to check whether every possible token equals one of the valid next outputs, the trie 890 can be used to eliminate the need to check branches that do not have a common prefix with a valid next output. FIG. 17 illustrates an example multi-step process for branch elimination to reduce the number of comparisons. Only an output starting with “t” or “b” is valid. Therefore, in a first step all branches starting with a character other than “t” or “b” are eliminated. For an output starting with “t”, the only valid next character is “i”, and for an output starting with “b”, the only valid next character is “o”. Therefore, in a second step all branches not starting with “ti” or “bo” are eliminated. This continues until all that is left are the tokens that are valid next outputs. The trie 890 may therefore make it faster (fewer computer operations) to compute the valid tokens. In another example involving trie 890, if the sequence of tokens already output from LLM 502 is “ . . . if pagetitle=”, the next valid token may be “black” or “blue”. Without trie 890, it would be necessary to evaluate, for each token of the LLM 502, whether that token has the value “black” or “blue” or a prefix thereof. However, with the trie 890, the fact that “black” and “blue” share the common prefix “bl” can be leveraged to eliminate checking all tokens not having the common prefix “bl”. In the example, only the tokens “black”, “blue”, and “blur” may need to be checked to see which ones equal “black” or “blue” (or a prefix thereof).

In view of the example above explained in relation to FIGS. 16 and 17, it will be appreciated that in some implementations of the method of FIG. 14 the set of valid next tokens may be generated by determining, for each token of a plurality of tokens, whether that token is in the set of valid next tokens. However, this does not necessarily need to involve a comparison of every possible token that can be output by the generative language model to the valid next outputs. That is, the plurality of tokens does not need to include every possible token that can be generated by the generative language model. Instead, in some implementations, the plurality of tokens may be a set of tokens containing fewer than all possible tokens that can be generated by the generative language model, and the set of tokens may be determined by retrieving all tokens having a prefix equal to a start of a next possible valid token. For example, in the example described in relation to FIGS. 3 to 5, only the tokens starting with “t” or “b” may be retrieved and evaluated to see if they are valid next output. In some implementations, all possible tokens that can be generated by the generative language model may be stored in the form of a tree. In some implementations, the set of tokens may correspond to at least one branch of the tree and fewer than all branches of the tree. Each branch may be associated with tokens having a common prefix. For example, in FIG. 16 there is a trie 890 storing all possible tokens that can be generated by LLM 502 in the form of a tree, and as per the second step of FIG. 17 the set of tokens correspond to only two branches of the trie 890.

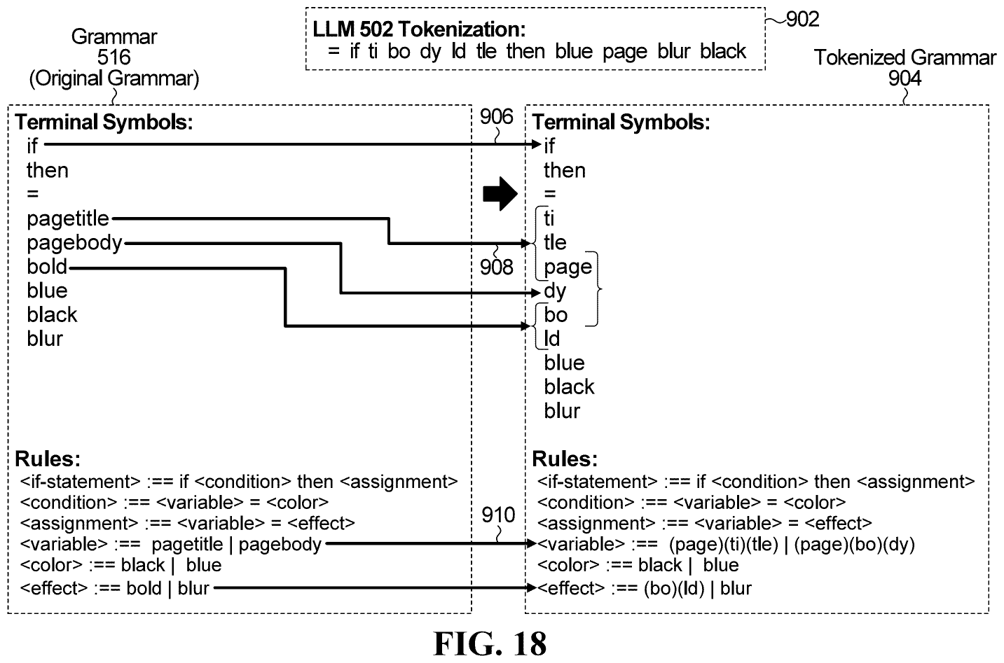

In some implementations of the method of FIG. 14, the grammar may be tokenized to match the tokenization of the generative language model. The “tokenization” of the generative language model refers to the tokens of the generative language model, e.g. the set of tokens that make up the universe of possible tokens that can be output by the generative language model. Tokenizing the grammar refers to modifying the terminal symbols of the grammar so that each terminal symbol is equal to a respective token of the grammar. The rules of the grammar may also need to be modified. To demonstrate, FIG. 18 illustrates an example of grammar tokenization assuming the example explained earlier in relation to FIGS. 3 to 5 in which the grammar 516 and LLM 502 are defined. Recall that the LLM 502 can only generate one of the following tokens: =if ti bo dy ld tle then blue page blur black. As shown in stippled box 902 of FIG. 18, this set of tokens is the tokenization of the LLM 502. Original grammar 516 is tokenized to result in tokenized grammar 904, as follows. The original grammar 516 is modified by, for each terminal symbol of the grammar 516 that consists of a series of tokens of the LLM 502, that terminal symbol is divided into a plurality of constituent symbols, where each constituent symbols corresponds to a respective corresponding token of the LLM 502. For example, no modification is needed for the terminal symbol “if”, because “if”’ is also one of the tokens of the LLM 502. Therefore, the terminal symbol “if” is not modified in the tokenized grammar 904, as shown at 906. However, the terminal symbol “pagetitle” consists of a series of tokens of the LLM 502, specifically “page” followed by “ti”, followed by “tle”. Therefore, “pagetitle” is divided into its three constituent symbols “page”, “ti”, and “tle”, and these constituent symbols become terminal symbols of the tokenized grammar 904, as shown at 908. Similarly, terminal symbol “pagebody” in grammar 516 is represented as three constituent terminal symbols “page”, “bo”, and “dy” in tokenized grammar 904, and terminal symbol “bold” in grammar 516 is represented as two constituent symbols “bo” and “Id” in tokenized grammar 904. Any rules of the grammar 516 that involve terminal symbols divided into constituent symbols are also modified to replace the terminal symbol with its constituent symbols. For example, as shown at 910, the rule <variable> is modified to define a variable as either “page” followed by “ti” followed by “tle” or instead “page” followed by “bo” followed by “dy”. This is illustrated using parenthesis around each symbol, e.g. (page) (ti) (tle). Similarly, the rule <effect> is modified to define an effect as either “bo” followed by “Id” or instead “blur”.

The technical benefit of using a tokenized grammar in the method of FIG. 14 is that using the grammar to constrain the output of generative language model may be simpler because it is not necessary to maintain any state associated with terminal symbols of the grammar. For example, in original grammar 516, if the LLM 502 outputs the token “page”, the grammar 516 is searched and it is determined that either “pagetitle” or “pagebody” are the only two valid sequences. However, “title” and “body” are not tokens that can be output by the LLM 502. The valid next tokens need to be determined by comparing the tokenization of the LLM 502 to “title” and “body”, and it is determined that “ti” and “bo” are valid next tokens. The LLM 502 is then constrained by the mask to output either “ti” or “bo”. Once this next valid token is obtained, it must be retrieved from memory that “pagetitle” or “pagebody” is the word being spelled. That is, the current state of what is being spelled (“pagetitle” or “pagebody”) must be stored and retrieved from memory, and this must be used to determine the next valid token. On the other hand, if the tokenized grammar 904 is instead being used to constrain the output of the LLM 502, each token output by the LLM 502 equals a terminal symbol. It is just necessary to determine, using the rules of the tokenized grammar 904, what is the next valid terminal symbol(s)/token(s). For example, if “page” is output from the LLM 502, the rule <variable> indicates that the next token that must be output from the LLM 502 is either “ti” or “bo”. There is no need to consider longer words that are formed of a series of tokens.

In view of the examples and explanation above, it will be appreciated that in some implementations of the method of FIG. 14, the grammar could be a tokenized grammar. For example, the grammar may be such that for each terminal symbol of one or more of the terminal symbols, the terminal symbol is divided into two or more constituent symbols, each constituent symbol corresponding to a respective possible output token that can be generated by the generative language model. The valid sequences of output defined by the grammar include valid sequences of output tokens based on the constituent symbols. An original grammar may be tokenized as follows. The original grammar is obtained. An indication of the tokens that can be output by the generative language model is also obtained. The original grammar is then modified to result in the tokenized grammar by, for each terminal symbol of one or more of the terminal symbols of the original grammar, dividing the terminal symbol into the two or more constituent symbols, where each constituent symbol corresponds to a respective possible output token that can be generated by the generative language model.

Technical benefits of some implementations herein are as follows. The generative language model is advantageously modified in the manner explained herein to be able to generate output that is always grammar compliant, e.g. by applying the mask in the manner explained herein. This represents an improvement in the functionality of the generative language model and hence the computing system implementing the generative language model because it may mitigate the technical problem of syntactically-invalid or misinformed output. For example, the generative language model may be modified to incorporate application of the mask (e.g. like in the examples shown in FIGS. 4 and 5, 7 and 8, and 10 and 11), such that the generative language model can only select a next token that is valid, i.e. a next token that when appended to the already-generated token sequence maintains the grammar-compliance of the sequence. The generative language model is thereby modified and improved to limit its output to only a sequence of grammar-compliant tokens, that is, a valid sequence defined by the grammar. This can also result in a more efficient implementation compared to not modifying the generative language model to apply the mask, but instead checking for grammar compliance of a next token after that next token is output from the generative language model. In an implementation in which the next token is generated by the generative language model without regard to the grammar, and then a separate step is performed to check for grammar compliance, there will be inefficiencies if that next token is not grammar compliant. It will be necessary to have the generative language model generate a new token, then check that new token, and if it is also not grammar-compliant then repeat the process again in an iterative manner until a token is output from the generative language model that is determined to be grammar-compliant. Not only does this result in multiple iterations, but for those multiple iterations to be implemented the generative language model would need to store the probabilities of each token being a next token until the iterative process is complete, that is, until the generative language model finally outputs a token that is grammar compliant. By instead modifying the generative language model in the way described herein, e.g. by applying the mask, the generative language model always and only outputs a next token that is grammar-compliant. The multiple iterations just described would not need to be performed, which results in fewer computing resources and faster speed.

In a different implementation, the most probable tokens output from the generative language model (e.g. output from the softmax function) may be compared to the grammar, and a grammar-compliant token selected as the next token, e.g. the next token may be the most probable next token that is also grammar-compliant. However, this suffers from the same multiple-iteration problem discussed above. For example, if the top one hundred most probable tokens are output by the generative language model, and if there are no grammar-compliant tokens in that set of one hundred tokens, then the generative language model needs to output the next top one hundred most probable tokens, and this continues until a grammar compliant token is found. While this is happening, the generative language model needs to halt operation and retain in memory the probability value for every token so that it can output different subsets of tokens (e.g. each subset of a size of one hundred tokens) over the multiple iterations. Moreover, in a scenario that there is a grammar-compliant token in the subset of the top one hundred most probable tokens, then another grammar-compliant token that is not in the subset of top one hundred most probable tokens can never be chosen as the next token, which is a form of undesirable skewing. In contrast, in implementations herein, the generative language model is modified to perform masking so that it will only output a token that is grammar-compliant, and all grammar-compliant next tokens have a chance of being selected. This avoids the multiple iterations described above (thereby reducing computations) and also avoids the undesirable skewing issue described above.

In some implementations herein, the application of the mask may be efficiently applied/implemented, e.g. through a tensor product or vector product, like in the examples of FIGS. 4 and 5, 7 and 8, and 10 and 11. The generative language model may already be optimized (e.g. by use of a GPU) to perform specialized operations/computations like tensor products in order to execute other operations of the generative language model. Therefore, implementing the mask also as a tensor product (like in the example of FIG. 4, 7, or 10) or similar (e.g. the vector product of the example of FIG. 5, 8, or 11) uses the same type of operation the generative language model is already optimized to perform, thereby reducing/optimizing computer operations required to perform the mask operation. The result is a more computationally efficient implementation, e.g. compared to an alternative implementation in which the generative language model is not modified, but instead the check for grammar compliance is done as a separate step after the token is generated.

In some implementations herein, the computing system can advantageously accommodate scenarios in which the tokens output by the generative language model include tokens that are only a portion of a valid terminal symbol of the grammar. This may be implemented by the determining the set of valid next tokens based on the token sequence already generated by the generative language model and based on the grammar, in the manner explained herein. For example, a terminal symbol of the grammar may be “pagetitle”, but the generative language model does not need to have such a token. The tokens output by the generative language model may include portions of the terminal symbol, e.g. “page”, “ti”, and “tle”. Given the previous token sequence (e.g. “ . . . if page”) and the grammar rules, the valid next tokens may be determined, which may only be a portion of a terminal symbol (e.g. “ti” determined to be a valid next token given “ . . . if page”). The computing system is improved because it can implement and accommodate generative language models that produce a variety of tokens, rather than having to be limited to a generative language model that only produces a token equal to a terminal symbol of the grammar. Moreover, in implementations in which the grammar is tokenized to match the tokenization of the generative language model (like in the example of FIG. 18), constraining the output of the generative language model using the grammar may be easier because each terminal symbol of the grammar equals a token of the generative language model, as described above.

In implementations herein in which a tree is used to store the tokens of the generative language model, e.g. the example explained in relation to FIGS. 16 and 17, the number of computations may be reduced to determine valid next tokens because branches of tree can be eliminated that do not have a common prefix with a valid next input, e.g. like in the steps of FIG. 17. This reduces the number of computations that would otherwise have to be executed by the computer, which improves the computer functionality.

Finally, there are also several additional technical benefits specifically in relation to an implementation in which there are multiple processing units, e.g. where there are separate first and second processing units like in FIG. 12. The generative language model can be implemented on a first processing unit that is specialized for executing the operations of a machine learning model, e.g. performing the tensor products in the neural network. For example, the first processing unit may be a GPU. The first processing unit may be primarily or solely dedicated to just implementing the generative language model, e.g. through a parallel structure dedicated to accelerating computer operations, and may efficiently perform operations such as tensor products. The first processing unit may be configured to apply the mask as part of implementing the generative language model, e.g. as an additional or final layer. The application of the mask may be implemented in the same way as other product operations (e.g. as a tensor or vector product), which the first processing unit is already specialized to perform. This may result in computationally efficient application of the mask. The second processing unit may communicate with the first processing unit over a network or bus. The second processing unit need not be specialized to execute the generative language model, but may be a more general purpose processor such as a CPU. The second processing unit may perform a variety of supporting operations that leverage the generative language model. For example, the second processing unit may provide a user interface to the user, receive the prompt from the user, process the output from the generative language model, etc. The second processing unit may store the grammar and generate the mask so that this need not be done by the generative language model, thereby advantageously allowing for the first processing unit to implement a generative language model that is not specific to a grammar even though it produces a grammar-compliant output. The first processing unit need only return the next token to the second processing unit (like in FIG. 12), rather than probability values (e.g. log it values) generated in the generative language model.

In the different implementation described earlier in which the most probable tokens output from the generative language model (e.g. the top 100 most probable tokens) are output and compared to the grammar, it would be necessary to send the tokens and/or the plurality of probability values corresponding to those tokens over the network or bus from the first processing unit (e.g. GPU) to the second processing unit (e.g. CPU). This would need to occur for every iteration. Moreover, the comparison of those tokens to the grammar to determine whether each one is grammar-compliant would need to occur on the second processing unit, which in general is slower because the second processor is not specialized. For example, assuming the second processing unit is a CPU, it would take many CPU cycles to validate the top one hundred most probable next tokens for every token generation step, and if a valid (grammar-compliant) token is not in the top one hundred most probable next tokens it would be required to obtain a different and/or larger set of tokens to check. This suffers from the problems of the multiple iterations and the skewing issue described above, and also the transfer of multiple values from the first processing unit to the second processing unit. Alternatively, in the implementation described in relation to FIG. 12, it is not necessary to transmit all of a tensor and/or multiple tokens between the first processing unit (e.g. GPU) and the second processing unit (e.g. CPU). Instead, only the next token generated by the generative language model needs to be transmitted from the first processing unit to the second processing unit (as shown at step 638 of FIG. 12) because that next token is always grammar compliant. That is, instead of sending some or all of a tensor and/or tokens between the first and second processing units, a mask 674 is constructed on the second processing unit using the token sequence 680 and grammar 678, and that mask 674 is then sent to the first processing unit (at step 634), and then the mask 674 is applied in the generative language model to ensure that a next token 676 is generated that is always grammar-compliant. Then only that grammar-compliant next token 676 needs to be sent from the first processing unit to the second processing unit (at step 638). This results in an implementation that requires fewer transmissions between processing units and that is more computationally efficient than having to perform the multiple iterations described above in the alternative implementation.

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
obtaining a plurality of values generated using a generative language model, each of the values indicative of a probability of a respective token being a next token in a token sequence generated by the generative language model;
obtaining a mask based on at least one token of the token sequence already generated by the generative language model and based on a grammar defining valid sequences of output; and
applying the mask to the plurality of values, the mask operating on each value that corresponds to a token not compliant with the grammar to reduce or zero the probability of the corresponding token being the next token;
wherein the next token is determined based on the plurality of values after the mask is applied.

2. The computer-implemented method of claim 1, wherein obtaining the mask comprises:
determining a set of valid next tokens based on the at least one token of the token sequence already generated by the generative language model and based on the grammar, wherein the set of valid next tokens consists of one or more tokens any one of which, when appended to the token sequence, results in the token sequence still being compliant with the grammar; and
generating the mask by, for each token not in the set of valid next tokens, generating a corresponding masking value that, when applied, reduces or zeros the probability of the token being the next token.

3. The computer-implemented method of claim 2,
wherein obtaining the plurality of values comprises generating a first tensor in a neural network of the generative language model, the first tensor including the plurality of values;
wherein the mask is a second tensor; and
wherein applying the mask comprises performing a tensor product of the first tensor and the second tensor.

4. The computer-implemented method of claim 3, wherein tokens not in the set of valid next tokens are invalid next tokens, and wherein:
at each position in the second tensor that corresponds to a valid next token there is an identity element that does not modify the value in the first tensor corresponding to the valid next token when the tensor product is performed; and
at each position in the second tensor that corresponds to an invalid next token there is the corresponding masking value that does modify the value in the first tensor corresponding to the invalid next token when the tensor product is performed to reduce or zero the probability of the invalid next token being the next token.

5. The computer-implemented method of claim 1, wherein the plurality of values is a plurality of normalized probability values output from a softmax function of the generative language model, and wherein applying the mask comprises reducing or setting to zero probability each of the normalized probability values that corresponds to a token not compliant with the grammar.

6. The computer-implemented method of claim 2,
wherein generating the plurality of values using the generative language model and the applying the mask is implemented on a first processing unit;
wherein the determining the set of valid next tokens and the generating the mask is implemented on a second processing unit; and
wherein the method further comprises transmitting the mask from the second processing unit to the first processing unit.

7. The computer-implemented method of claim 6, wherein the first processing unit is a graphics processing unit (GPU) and the second processing unit is a general purpose processor.

8. The computer-implemented method of claim 2, comprising determining, for each token of a plurality of tokens, whether that token is in the set of valid next tokens.

9. The computer-implemented method of claim 8, wherein the plurality of tokens is a set of tokens containing fewer than all possible tokens that can be generated by the generative language model, and wherein the set of tokens is determined by retrieving all tokens having a prefix equal to a start of a next possible valid token.

10. The computer-implemented method of claim 9, wherein all possible tokens that can be generated by the generative language model are stored in the form of a tree, and wherein the set of tokens corresponds to at least one branch of the tree and fewer than all branches of the tree.

11. The computer-implemented method of claim 1, wherein the grammar defines terminal symbols and one or more rules that define how the terminal symbols can be arranged in relation to each other to define the valid sequences of output.

12. The computer-implemented method of claim 11, wherein for each terminal symbol of one or more of the terminal symbols, the terminal symbol is divided into two or more constituent symbols, each constituent symbol corresponding to a respective possible output token that can be generated by the generative language model; and wherein the valid sequences of output defined by the grammar include valid sequences of output tokens based on the constituent symbols.

13. The computer-implemented method of claim 12, wherein the grammar before the terminal symbol is divided into the two or more constituent symbols is an original grammar, wherein the grammar after the terminal symbol is divided into the two or more constituent symbols is a tokenized grammar, and wherein generating the tokenized grammar comprises:
obtaining the original grammar and obtaining an indication of the tokens that can be output by the generative language model; and
modifying the original grammar to result in the tokenized grammar by, for each terminal symbol of one or more of the terminal symbols of the original grammar, dividing the terminal symbol into the two or more constituent symbols, each constituent symbol corresponding to a respective possible output token that can be generated by the generative language model.

14. A system comprising:
a memory to store a grammar defining valid sequences of output; and
at least one processing unit to:
obtain a plurality of values generated using a generative language model, each of the values indicative of a probability of a respective token being a next token in a token sequence generated by the generative language model;
obtain a mask based on at least one token of the token sequence already generated by the generative language model and based on the grammar defining the valid sequences of output; and
apply the mask to the plurality of values, the mask operating on each value that corresponds to a token not compliant with the grammar to reduce or zero the probability of the corresponding token being the next token;
wherein the next token is determined based on the plurality of values after the mask is applied.

15. The system of claim 14, wherein the at least one processing unit is further to:
determine a set of valid next tokens based on the at least one token of the token sequence already generated by the generative language model and based on the grammar, wherein the set of valid next tokens consists of one or more tokens any one of which, when appended to the token sequence, results in the token sequence still being compliant with the grammar; and
generate the mask by, for each token not in the set of valid next tokens, generating a corresponding masking value that, when applied, reduces or zeros the probability of the token being the next token.

16. The system of claim 15,
wherein the at least one processing unit is to obtain the plurality of values by generating a first tensor in a neural network of the generative language model, the first tensor including the plurality of values;
wherein the mask is a second tensor; and
wherein the at least one processing unit is to apply the mask by performing a tensor product of the first tensor and the second tensor.

17. The system of claim 16, wherein tokens not in the set of valid next tokens are invalid next tokens, and wherein:
at each position in the second tensor that corresponds to a valid next token there is an identity element that does not modify the value in the first tensor corresponding to the valid next token when the tensor product is performed; and
at each position in the second tensor that corresponds to an invalid next token there is the corresponding masking value that does modify the value in the first tensor corresponding to the invalid next token when the tensor product is performed to reduce or zero the probability of the invalid next token being the next token.

18. The system of claim 14, wherein the plurality of values is a plurality of normalized probability values output from a softmax function of the generative language model, and wherein the at least one processor is to apply the mask by reducing or setting to zero probability each of the normalized probability values that corresponds to a token not compliant with the grammar.

19. The system of claim 15,
wherein the at least one processing unit comprises a first processing unit and a second processing unit;
wherein the first processing unit is to generate the plurality of values using the generative language model and apply the mask;
wherein the second processing unit is to determine the set of valid next tokens, generate the mask, and transmit the mask to the first processing unit.

20. The system of claim 19, wherein the first processing unit is a graphics processing unit (GPU) and the second processing unit is a general purpose processor.

21. The system of claim 15, wherein the at least one processor is to determine, for each token of a plurality of tokens, whether that token is in the set of valid next tokens, wherein the plurality of tokens is a set of tokens containing fewer than all possible tokens that can be generated by the generative language model, and wherein the at least one processor is to determine the set of tokens by retrieving all tokens having a prefix equal to a start of a next possible valid token.

22. The system of claim 21, wherein all possible tokens that can be generated by the generative language model are stored in the form of a tree, and wherein the set of tokens corresponds to at least one branch of the tree and fewer than all branches of the tree.

23. The system of claim 14, wherein the grammar defines terminal symbols and one or more rules that define how the terminal symbols can be arranged in relation to each other to define the valid sequences of output.

24. The system of claim 14, wherein for each terminal symbol of one or more of the terminal symbols, the terminal symbol is divided into two or more constituent symbols, each constituent symbol corresponding to a respective possible output token that can be generated by the generative language model; and wherein the valid sequences of output defined by the grammar include valid sequences of output tokens based on the constituent symbols.

25. One or more non-transitory computer-readable storage media having stored thereon computer-executable instructions that, when executed by at least one processing unit, cause the at least one processing unit to perform operations comprising:
obtaining a plurality of values generated using a generative language model, each of the values indicative of a probability of a respective token being a next token in a token sequence generated by the generative language model;
obtaining a mask based on at least one token of the token sequence already generated by the generative language model and based on a grammar defining valid sequences of output; and
applying the mask to the plurality of values, the mask operating on each value that corresponds to a token not compliant with the grammar to reduce or zero the probability of the corresponding token being the next token;
wherein the next token is determined based on the plurality of values after the mask is applied.
